(19) United States
(12) Patent Application Publication
(10) Pub. No.: US 2003/0009373 A1
(43) Pub. Date: Jan. 9, 2003

(54) System and method for addressing a performance improvement cycle of a business

(75) Inventors: David Ensing, Toledo, OH (US); Michael Brereton, Farmington Hills, MI (US); Curt E. Rose, Toledo, OH (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Maritz Inc.

(21) Appl. No.: 10/180,397

(22) Filed: Jun. 26, 2002

Related U.S. Application Data
(60) Provisional application No. 60/301,263, filed on Jun. 27, 2001.

(51) Int. Cl. G06F 17/60

(52) U.S. Cl. 705/10

(57) ABSTRACT

A system for evaluating and responding to customer satisfaction index (CSI) data generated by businesses such as automotive dealers and call centers. The system includes a reporting module providing on-line reporting of the CSI data, a diagnostic module for generating comparisons and for identifying issues relating to the CSI data, a research module for conducting on-line research relating to the generated comparisons and identified issues, a procedures module for viewing business procedures relating to the generated comparisons and identified issues, a training module for providing and tracking via on-line and/or off-line training affecting the generated comparisons, the identified issues and/or the procedures, a sales and recognition building module tracking motivation programs, and a customer retention module.

### NOTICE

Copyright 2001 Maritz Inc. A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates to the field of customer satisfaction. In particular, this invention relates to evaluating and responding to customer satisfaction index data.

2. Description of the Prior Art

Some prior art systems calculate customer satisfaction index (CSI) data via paper-based processes. With these systems, paper reports are prepared with collected CSI data and then sent to recipients. Other electronic systems process CSI data and electronically deliver prepared reports on-line. There is a need for a system that automatically notifies users of important CSI issues and provides resource mapping to allow users to quickly address and rectify these issues.

A processor delivers data in response to complex queries by a user. Some processors allow the user to re-calculate data quickly by updating the database with additional data. In some environments where the data is accessible by multiple users, however, immediate re-calculation of data based on new data prevents accurate data analysis. As such, there is a need for a processor that permits accurate comparison of CSI data by prohibiting user-level database updates and re-calculation of data.

Other prior art systems include web-based reporting software. In such systems, the prior art software accesses raw data and allows users to manipulate the data. However, there is a need for a system which analyzes and presents pre-summarized CSI data. In addition, there is a need for a system which provides standardized, interlinked reports which process, sort, and code CSI data.

The invention described below addresses these and other disadvantages.

### SUMMARY OF THE INVENTION

In general, the system and method of the invention provide specialized tools which allow channel partners or other users to explore customer satisfaction index (CSI) data in detail, prioritize areas for improvement, and act on the CSI data to improve customer satisfaction. The CSI data reflects long-term tracking of customer satisfaction. For example, in the automotive industry, CSI data reflects customer satisfaction for automotive sales and service. Channel partners are able to drill into the CSI data by issue, by staff, or by customer to analyze the strengths and weaknesses within an organization as indicated by the CSI data. In one embodiment, the system and method include a web page that acts as the channel partner's home page and includes overall CSI scores as well as specialized reports based on statistical modeling that highlight those issues in need of improvement. Channel partners can also develop and display their own charts on this page to track issues of interest to them. Channel partners can identify issues that need attention, staff who need to improve in certain areas, and the impact identified issues have had on customers.

Once a CSI issue has been identified, the invention provides online resource mapping to allow the channel partner to address and rectify the identified CSI issue. In one embodiment, there are six resource modules in the invention that are mapped to the CSI data to allow a channel partner to address a performance improvement cycle of a business. The channel partner can perform supplemental research in a research module to narrow down the possible causes of the problem. The channel partner can view reported CSI data in a diagnostic module to identify issues relating to the CSI data. The channel partner can view pertinent business procedures relating to the CSI data in a procedures module. The channel partner can provide and track on-line and/or off-line training affecting the generated comparisons in a training module. The channel partner can also track the motivation programs and develop and implement incentive programs to encourage development of the business in a sales and recognition building module. The channel partner engages in relationship management between the business and the customer in a customer retention module to provide marketing activities to the customer.

In accordance with one aspect of the invention, a system user evaluates and responds to customer satisfaction index (CSI) data. The system includes a database that contains CSI data in a hierarchical format. The system further includes a processor that accesses the database and summarizes strengths and weaknesses indicated by the hierarchical CSI data. The system also provides a plurality of on-line service programs that impact the hierarchical CSI data. The system also includes a resource mapping tool that links the strengths and weaknesses with the on-line service programs.

In accordance with another aspect of the invention, a system evaluates and responds to hierarchical customer satisfaction index (HCSI) data. The system includes a data reporting tool that responds to user input and generates summary survey data from the HCSI data. The system further includes a diagnostic tool that responds to user queries and analyzes the summary survey data to generate comparisons and identify issues relating to the HCSI data. The system also provides a plurality of on-line service programs that impact the HCSI data. The system also includes a resource mapping tool that links the generated comparisons and identified issues with the on-line service programs.

In accordance with another aspect of the invention, a modular system analyzes HCSI data. The HCSI data is generated by a business directed toward customers according to business procedures and motivation programs. The modular system includes a reporting module that provides on-line reporting of the HCSI data. The modular system further includes a diagnostic module to view the reported HCSI data, and to generate comparisons and identify issues relating to the HCSI data. The modular system also includes a research module that conducts on-line research. The on-line research corresponds to marketing activities and customer satisfaction that relate to the generated comparisons and identified issues. The modular system also includes a procedures module to view pertinent business procedures that relate to the generated comparisons and identified issues. The modular system also includes a training module that provides and tracks on-line and/or off-line training programs that affect the generated comparisons, identified issues, and/or the pertinent procedures. The modular system also includes a sales and recognition building module to track motivation programs and to develop and implement incentive programs that encourage development of the business. The modular system also includes a customer retention module to engage in relationship management between the business and the customer 204 and to provide marketing activities to the customer.

In accordance with another aspect of the invention, a modular system analyzes HCSI data. The HCSI data is generated by a business directed toward customers according to business procedures and motivation programs. The modular system includes a reporting module that provides on-line reporting of the HCSI data. The modular system further includes a diagnostic module to view the reported HCSI data, and to identify the strengths and weaknesses of the HCSI data. The modular system also includes a training module that provides and/or tracks on-line and/or off-line training that affects the identified strengths and weaknesses.

In accordance with another aspect of the invention, a computerized system dynamically analyzes hierarchical CSI data in a database. The computerized system includes a data retrieval tool that responds to user input and dynamically generates a query to access the database and obtain selected CSI data. The computerized system also includes a report generating tool that dynamically generates a plurality of interlinked reports that include the selected CSI data. Each interlinked report has at least one dynamically linked item. The report generating tool further generates another report in response to a user selecting a dynamically linked item contained in the interlinked report.

In accordance with another aspect of the invention, a method identifies problems and prioritizes areas for improvement related to customer satisfaction. The method includes the step of providing an application program that accesses the database containing hierarchical CSI data. The method further includes the step of allowing a user to select and view one or more interlinked reports via the application program. The interlinked reports include dynamically linked items and selected CSI data. The method also includes the step of allowing the user to select one of the dynamically linked items contained in the interlinked reports to dynamically display another report.

In accordance with another aspect of the invention, a computerized system dynamically analyzes hierarchical CSI data contained in a database. The system includes a processor that dynamically generates a query in response to user input. The query accesses the database and obtains selected CSI data. The processor further dynamically generates a plurality of interlinked reports that include the selected CSI data. Each of interlinked reports has at least one dynamically linked item. The processor further dynamically generates another report in response to a user selecting a dynamically linked item contained in the interlinked reports.

In accordance with another aspect of the invention, a system improves customer satisfaction. The system includes a report system that collects and stores hierarchical CSI data. The report system further generates interlinked reports that display selected CSI data. The system also includes a diagnostic system that analyzes the CSI data. The diagnostic system provides dynamic query generation and execution on the CSI data to dynamically display the interlinked reports.

In accordance with another aspect of the invention, a computerized system analyzes customer satisfaction issues in transactions conducted between a customer and a representative. The computerized system includes a database for storing CSI data. The computerized system also includes a processor that responds to user input to process the CSI data and summarize the strengths and weaknesses of the representatives as indicated by the CSI data. The computerized system also includes a reporting tool that provides the user improvement programs that relate to the summarized strengths and weaknesses of representatives.

It is an object of this invention to provide an electronic system that processes CSI data and electronically delivers prepared reports to recipients.

It is another object of this invention to provide a processing system that permits accurate comparison of CSI data by prohibiting database updates by the channel partner and re-calculation of data.

It is another object of this invention to provide a system that analyzes, prioritizes, sorts, codes and presents pre-summarized CSI data.

It is another object of this invention to provide a system which provides standardized, interlinked, resources which allow users to address and rectify identified CSI issues.

### BRIEF DESCRIPTION OF THE DRAWINGS

FIG. 1 is a block diagram-of one preferred embodiment of the system and method of the invention illustrating the main aspects.

FIG. 1A is a detailed flow chart of one preferred embodiment of the system and method of the invention illustrating operation of the invention.

FIG. 1B is a block diagram of one preferred embodiment of the system and method of the invention illustrating components of the resource mapping tool.

FIG. 2 is a block diagram of one preferred modular embodiment of the system and method of the invention illustrating the main modules.

FIG. 3 is a block diagram of one preferred embodiment of the system and method of the invention illustrating channel partner interaction with the diagnostic application program and the database of CSI data.

FIG. 4 is a block diagram of one preferred embodiment of the system and method of the invention illustrating channel partner interaction with the data retrieval tool for accessing the database of CSI data to produce reports via the report generating tool.

FIG. 5 is an exemplary embodiment of the system and method of the invention illustrating a home page for accessing the diagnostic tool.

FIG. 6 is an exemplary embodiment of the system and method of the invention illustrating a diagnostic home page highlighting the strengths and weaknesses of the CSI data.

FIG. 7 is a summary chart in one preferred embodiment of the system and method of the invention comparing each salesperson's scores to the average score for a specific section of the CSI questionnaire.

FIG. 8 is a chart in one preferred embodiment of the system and method of the invention showing each salesperson's score compared to the section mean for the attribute Understood Your Vehicle Needs.

FIG. 9 is a graph in one preferred embodiment of the system and method of the invention illustrating a specific salesperson's average scores for the attribute Understood Your Vehicle Needs compared to the dealership average over the past year.

FIG. 10 is a chart in one preferred embodiment of the system and method of the invention illustrating the customers' responses for a specific salesperson during a selected time period.

FIG. 11 is an exemplary embodiment of the system and method of the invention illustrating a scanned customer satisfaction survey.

FIG. 12 is a survey template in one preferred embodiment of the system and method of the invention customized to assess issues surrounding the attribute Understanding Your Customer Needs.

FIG. 13 is a template in one preferred embodiment of the system and method of the invention in which the automotive dealer customizes each question in the survey.

FIG. 14 is a template in one preferred embodiment of the system and method of the invention illustrating the customized survey.

FIG. 15 is a menu in one preferred embodiment of the system and method of the invention illustrating the deployment options available to the dealer.

FIG. 16 is a user interface in one preferred embodiment of the system and method of the invention illustrating the entry of customer information and the contents of the survey invitation to be sent to potential respondents.

FIG. 17 is a table in one preferred embodiment of the system and method of the invention listing the respondents to the deployed survey.

FIG. 18 is a user interface in one preferred embodiment of the system and method of the invention illustrating updated, summarized results for each survey question.

FIG. 19 is an exemplary embodiment of the system and method of the invention illustrating the retail operating procedures contained in the Procedures Library for the attribute Understanding Customers Needs.

FIG. 20 is an exemplary embodiment of the system and method of the invention illustrating the available training resources within the training module for the attribute Salesperson Interviewing Skills.

FIG. 21 is a typical enrollment form in one preferred embodiment of the system and method of the invention facilitating registration for the selected course.

FIG. 22 is a user interface in one preferred embodiment of the system and method of the invention illustrating the parameters selectable to find customers.

FIG. 23 is an exemplary block diagram illustrating the basic components of a system for implementing the invention.

FIG. 24 is an exemplary block diagram illustrating the contents of a automotive CSI database storing data relating to customer satisfaction issues in automotive transactions.

FIG. 25 is an exemplary block diagram illustrating the operations of an automotive processor for analyzing customer satisfaction issues in automotive transactions.

FIG. 26 is an exemplary block diagram illustrating the contents of a call center CSI database storing data relating to customer satisfaction issues in call center transactions.

FIG. 27 is an exemplary block diagram illustrating the operations of a call center processor for analyzing customer satisfaction issues in call center transactions.

Corresponding reference characters indicate corresponding parts throughout the drawings.

### DETAILED DESCRIPTION OF THE PROFFERED EMBODIMENTS

The system and method (herein system 100) of the invention include an integrated collection of tools that businesses use in improving customer satisfaction and in measuring performance. In particular, in businesses which are conducted by various franchises, users, or other channel partners, the system and method of the invention measure user performance. The system is flexible such that users may use each component independently as well as use all the components together to complete the process. Users include, but are not limited to, automotive dealers, automotive sales managers, and automotive service managers.

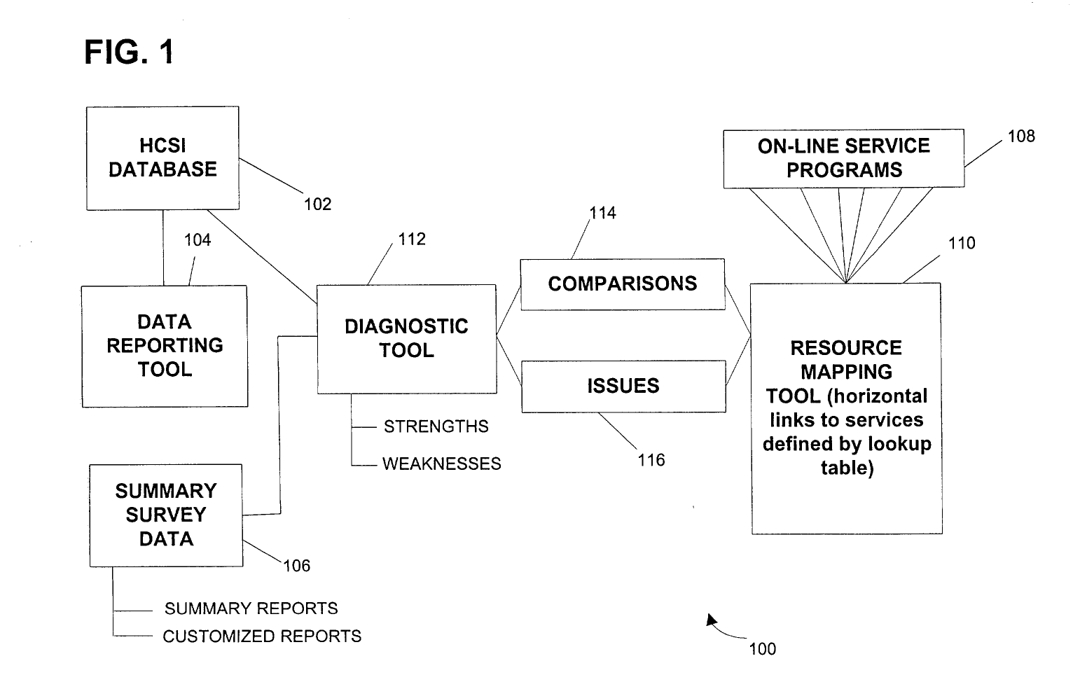

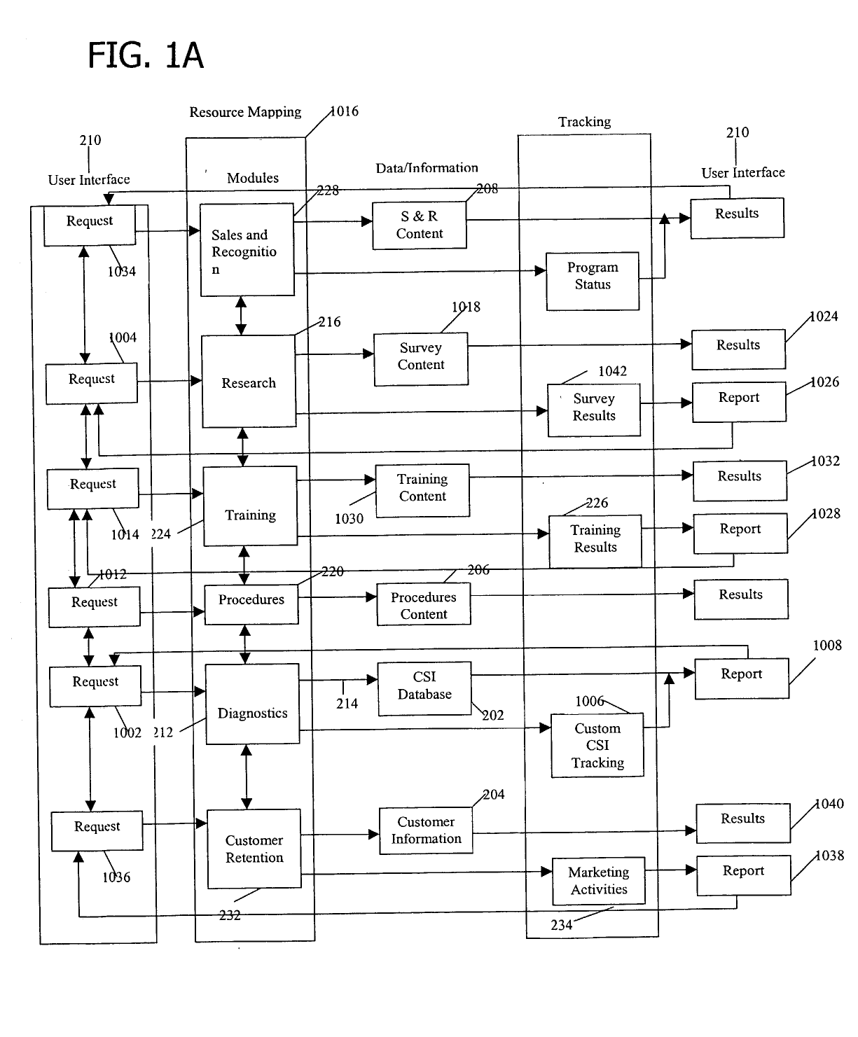

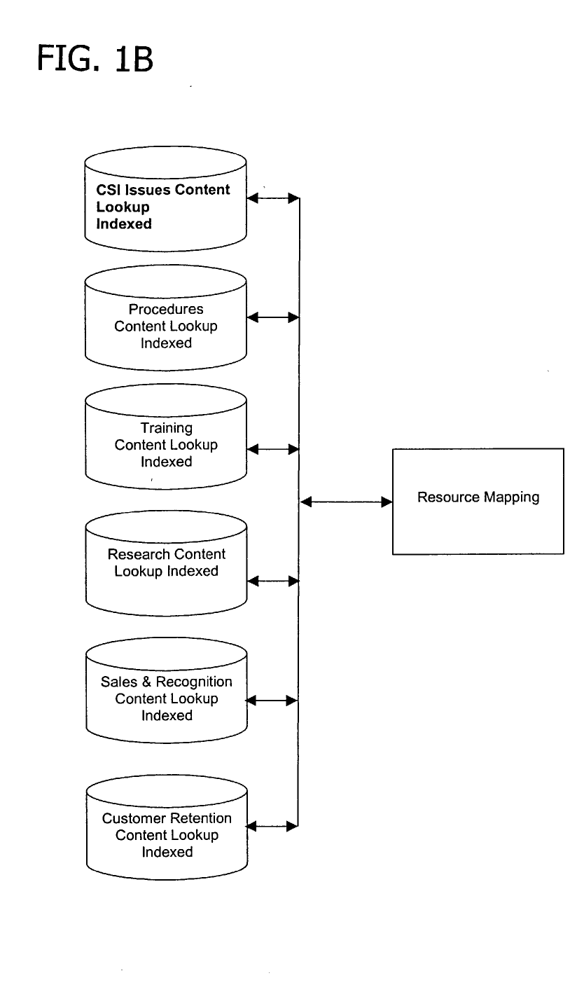

FIG. 1 is a functional block diagram of a system 100 for evaluating and responding to customer satisfaction index (CSI) data according to the invention. The system 100 includes hierarchical CSI (HCSI) data or other CSI data stored in an HCSI database 102. The CSI data may be arranged in client- or user-defined hierarchy. For example, in the automotive industry, the CSI data may be organized into national, regional, district, local, and dealership levels. A web-based data reporting tool 104 or other report system responsive to user queries from users and clients accesses the database 102 to report and store gathered HCSI data. Alternatively, the CSI data may be gathered via paper and input into the database 102. Tool 104 is, for example, a processor that is under user control. Tool 104 accesses the database 102 and the gathered HCSI data and provides a summary of survey data 106. A diagnostic tool 112 or other diagnostic system identifies the strengths and weaknesses indicated by the HCSI data 106. Diagnostic tool 112 assists the user in analyzing the summary survey data 106 by performing comparisons 114 to identify strengths and weaknesses within the issues 116 or attributes by generating comparisons relating to the HCSI data. The summary data may include summary reports and customized reports. The system 100 also includes a plurality of on-line service programs 108 which impact future HCSI data. A resource mapping tool 110 allows the user to link the strengths and weaknesses as identified by the diagnostic tool 112 with the on-line service programs 108. The resource mapping tool 110 includes horizontal links to provide targeted interactions based on the identified attributes and personnel.

Referring next to FIG. 1B, in one embodiment, the resource mapping tool 110 uses one or more lookup tables to link identified attributes with on-line services. For any related content within each of the modules, there is an indexed set of lookup tables containing appropriate material to support each module. Each module may or may not have relative information. For example, in the case of the attribute Understanding Vehicle Needs, the content is relative in CSI diagnostics, Training, Procedures, and Research, but not necessarily relative to Sales & Recognition and Customer Retention. The lookup table allows association between attributes identified as strengths or weaknesses and the appropriate content within a particular module. The lookup table also considers the job level of the person under consideration by the survey (e.g., the salesperson or serviceperson at the dealership). In particular, each attribute has a one-to-many relationship with the on-line services. In one embodiment, the lookup table is defined by the client. The following Table 1 is an exemplary lookup table in which one or more links to online services are selected based on factors such as the CSI score for the salesperson for each attribute. Another exemplary table may include links to online services for service personnel.

TABLE 1
Exemplary lookup table

| Attribute | Links to Online Services |
|---|---|
| Understanding Customer | Salesperson Listening Skills Training |
| Needs | Salesperson Needs Assessment Training |
| | Salesperson Interviewing Skills |
| | Training |
| Knowledge about | Salesperson Vehicle Training |
| Vehicles | |
| Explain Warranty | Salesperson Warranty Procedures |
| Coverage | |
| Test Drive | Salesperson Test Drive Procedures |

In one embodiment, the strengths and weaknesses in the HCSI data are identified according to user- or client-defined criteria. The criteria include rules which operate to flag certain aspects of the HCSI data. For example, the rules may require that an attribute that has a CSI score which is a pre-defined percentage above or below a threshold be identified as a strength or weakness, respectively. The threshold may be a static value, or an average (e.g., regional, national, or local). Alternatively, an off-line prioritized analysis of the attributes in the survey may influence the rules developed for a specific client.

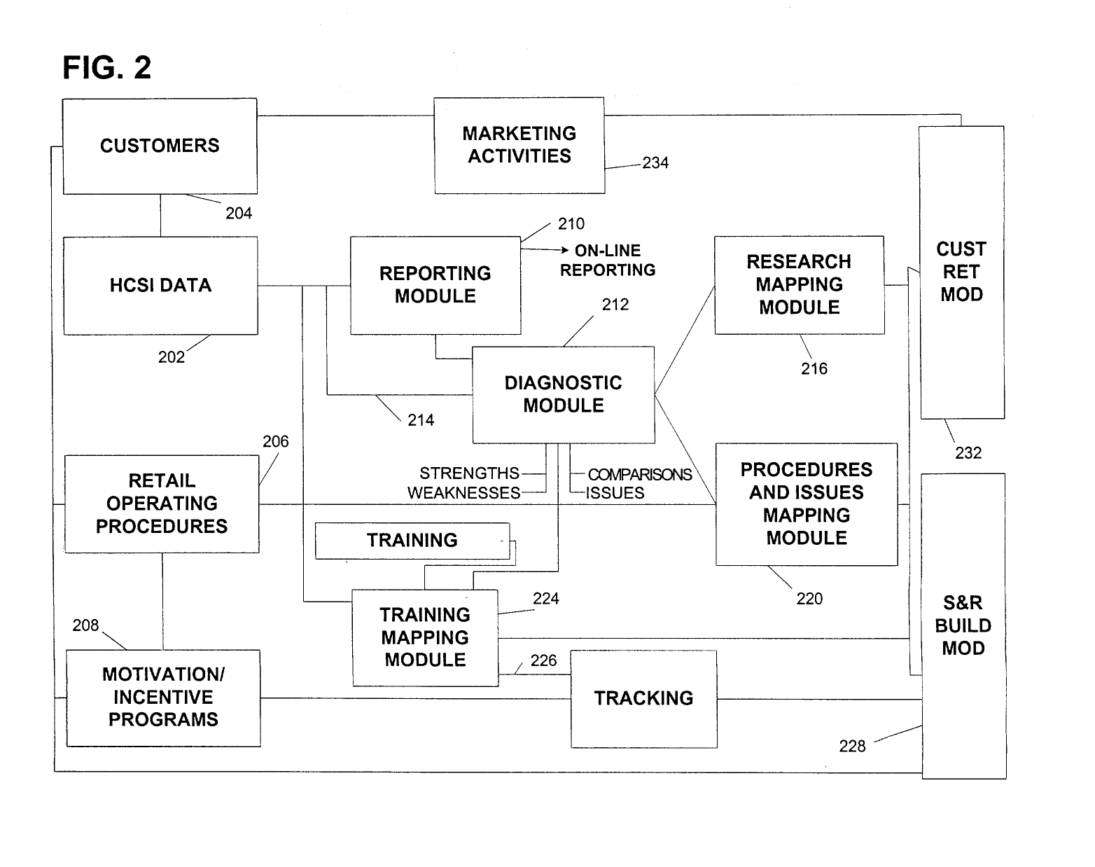

Preferably, the system according to the invention may be implemented as a modular system as illustrated in FIG. 2. In this configuration, the purpose of the system is to allow a user to analyze HCSI data 202 generated by a client's business directed toward customers 204. The business is preferably defined by business procedures 206 and motivation or incentive programs 208. The modular system includes a reporting module 210 responsive to user queries and providing on-line reporting of the HCSI data (such as the equest system provided by Maritz Inc.). The system also includes a diagnostic module 212 assisting in viewing the reported HCSI data via line 214 and for performing comparisons to identify strengths and weaknesses of the issues relating to the HCSI data. A research mapping module 216 enables the user to conduct directed on-line or other research directed to specific users. For example, a template could be available for use in gathering information for specific issues. This research relates to the generated comparisons and identified issues from the diagnostic module 212 and may include additional directed surveys. A procedures/issues mapping module 220 permits the user to view the pertinent business procedures. A training mapping module 224 provides and tracks for the user via line 226 on-line and/or off-line training affecting the generated comparisons, the identified issues, and/or the pertinent procedures. The system also includes a sales and recognition (S&R) building module 228 (such as the eMaritz motivation program system provided by Maritz Inc.) which tracks, develops, and operates the motivation/incentive programs 208 encouraging development of the business. The system may also include a customer retention module 232 (such as the Vault or evault loyalty program system provided by Maritz Inc.) engaging in relationship management between the business and the customer 204 and providing market activities 234 to the customer 204.

In one embodiment, after the HCSI data has been processed to identify the attributes that are strengths or weaknesses based on the CSI scores for those attribute, the identified attributes are sorted, color-coded, and inserted into a template for display to the user.

Operation of the System

Initially, the user (e.g., a channel partner) would employ the diagnostic module 212, which provides specialized tools, to allow them to explore their CSI data in detail and prioritize areas of improvement. Users are able to drill into data by issue, by staff or by customer. In an exemplary web-enabled embodiment, the diagnostic module 212 generates a plurality of diagnostic pages, each of which acts as a home page for a user and contains overall CSI scores as well as specialized reports based on statistical modeling that highlight those issues in need of improvement. Users can also develop and display their own charts on this page to track issues of interest to them. Through the use of this diagnostic module 212, users will be able to identify issues that need attention, staff who need to improve in certain areas and/or the impact identified issues have had on customers. Once an issue has been identified by use of the diagnostic module 212, a user can follow up with supplemental research to narrow down the possible causes of a problem associated with the issue. To do this, a user would navigate to the research module 216.

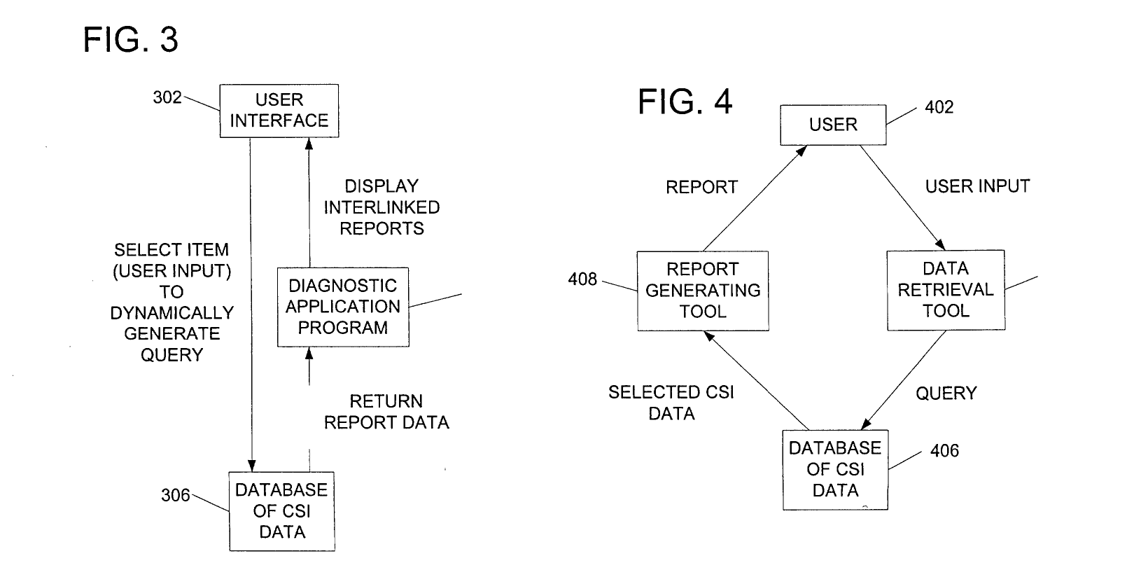

Referring next to FIG. 3, a user (e.g., channel partner) provides input by selecting an item in a report via a user interface 302. The user interface 302 dynamically generates a query to operate on a database 306 of CSI data. The database 306, in response to the query, returns the requested report data to a diagnostic application program 304. The diagnostic application program 304 displays the requested report data as part of the interlinked reports via the user interface 302. The reports include dynamically linked items and selected CSI data such that the user selects one of the dynamically linked items in the reports to dynamically display another report. The system 100 allows the user to select and view one or more interlinked reports via the diagnostic application program 304. In this manner, the user identifies problems and prioritizes areas for improvement related to customer satisfaction.

The user diagnoses and compares the CSI data by creating at least one query to produce the reports. The reports include the CSI data for a selected time period. The diagnostics application program 304 analyzes, sorts, and color-codes the CSI data to highlight strong and weak performance. In addition, the diagnostic application program 304 identifies and presents the CSI data based on pre-defined settings of the user. For example, the user may choose to view the CSI data over a three month interval. In one embodiment, the items relate to the CSI data of a dealer, customer, staff, or issue.

Referring next to FIG. 4, a user 402 provides input to a data retrieval tool 404 by requesting specific data. The data retrieval tool 404 generates in response to the user input a query to access and execute on a database 406 of CSI data to obtain selected CSI data. The database 406 returns the requested, selected CSI data to a report generating tool 408. The database 406 is accessible via a network and/or a software application program. The report generating tool 408 dynamically generates a plurality of interlinked reports including the selected CSI data for use by the user 402. Each of the reports has at least one dynamically linked item. The report generating tool generates another report in response to the user selecting the dynamically linked item. The item includes the dynamically-generated query. In one embodiment, the item is a hyperlink. The query dynamically produces another report by retrieving selected elements of the CSI data from the database 406. The query includes, but is not limited to, code or text. In one embodiment, the queries are customizable by the user to retrieve selected elements of the CSI data from the database 406.

In one embodiment, the database 406 includes local, regional, and national CSI data. The reports include summaries of strengths and weaknesses of the CSI data relating to a dealer, customer, staff, or issue. The database 406 includes averages of the CSI data from all dealers. In one embodiment, the database 406 is a relational database operative with a structured query language. The reports include selected elements of the CSI data for display on a web page. The reports include graphics and/or text. In another embodiment, the reports include charts customizable by the user to include selected CSI data.

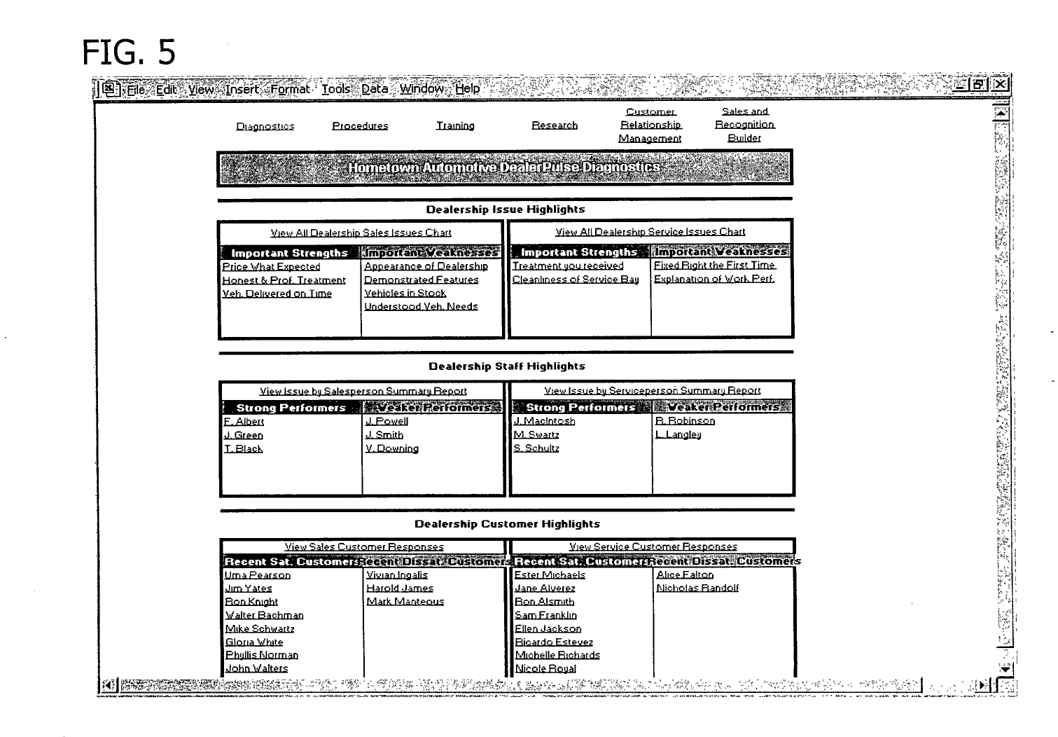

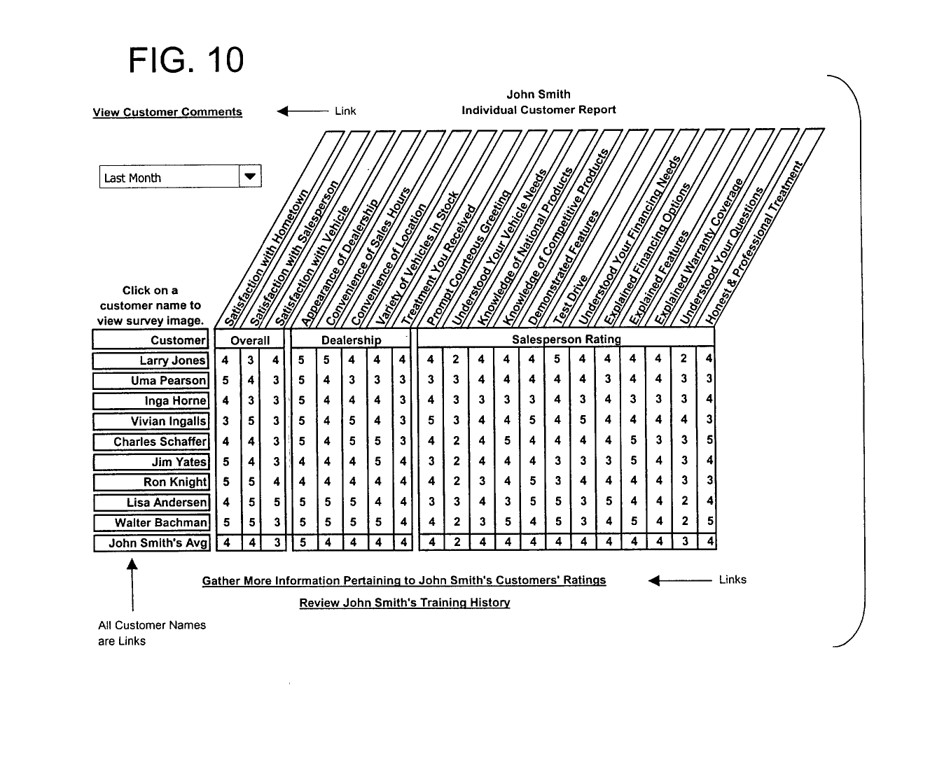

Referring next to FIG. 5, an exemplary home page for accessing the diagnostic tool 112 is illustrated for an automotive embodiment of the system 100. The home page is organized into the following sections: Dealership Issue Highlights, Dealership Staff Highlights, and Dealership Customer Highlights. The home page also provides links for further information relating to each of the above sections. See FIG. 10 below for another exemplary home page embodying the system 100.

Many questions can be answered by examining existing data. At times, however, users may need to collect more specific information from their customers or from potential customers. The research module 216 will allow users to quickly and easily build issue-specific surveys and deploy them using the web, telephone or mail methods. Survey templates for other types of surveys are also available, such as prospect follow up, lost lead follow up, brand image and ad campaign studies. In addition, links for ordering off-line research including customer follow up calls, mystery shopping and/or focus groups are provided. Ultimately, the research module 216 should provide for all the customer research needs of virtually any user. Once users identify areas in need of improvement, they will need to know what salespeople in their user organization need to do to improve.

The following is a listing of the menu options of the research module 216 including do-it-yourself options, survey development and deployment options and research services.

Do it Yourself

Web-based Questionnaire with e-mail invitations

Telephone Questionnaire

Mail Questionnaire

Survey Development & Deployment

Build custom surveys

Build a survey from a template

Manage survey returns

Use new sample with existing questionnaire

Research Services

Order a Mystery Shopping Program

Order a Focus Group Program

Order a Telephone Study

Order a Mail Study

The next step is employment of the procedures module 220 which provides retail sales procedures for such items as the shopping experience, the purchase experience, the delivery experience and follow up-contact experiences.

National Automotive Retail Sales Procedures

Shopping Experience

Greating and Introduction

Dealership Orientation

Gathering Customers' Needs

Listening to your Customer

Understanding your Customers' Needs

Selecting the Right Vehicle for your Customer

Purchase Experience

Delivery Experience

Follow-up Contact Experience

Through the use of an on-line learning and performance system (such as the Maritz On-Line Learning and Performance System provided by Maritz Inc.) all manufacturer or retail operating procedures may be placed on-line. Furthermore, through the resource mapping function of the research module 210, specific standards can be linked to specific diagnostic issues as identified by the diagnostic module 212. This allows users to have direct access to appropriate standards given the problem they have identified. Finally, web-based assessments can be performed to determine whether user personnel understand the procedures. At times, personnel of the users may know what they are supposed to do, but they may have trouble understanding how to do it. This leads to the training module 224.

The following illustrates exemplary training programs that can be available through the training module 224 sometimes referred to as the training library.

National Automotive Training Programs

Resource Library

Greeting and Introduction

Dealership Orientation

Gathering Customers' Needs

Listening to your Customer

Understanding your Customers' Needs

Selecting the Right Vehicle for your Customer

Skills Assessment

Management Reporting

System Administration

Personal Portfolio

The training module 224 allows businesses to publish all their training resources to one on-line library, whether web or classroom or CD-ROM-based, videotape or satellite, all with on-line registration and individual tracking functions. In this way, training expenses are minimized and the effect of training is maximized, through the use of resource mapping that suggests training options associated with issues that have been identified as having the most impact on business success. The training module 224 also contains a management reporting function that allows managers of users and corporate personnel to track individual progress, group progress, resource usage and training effectiveness.

Training is not the only way to effect change within an organization. For example, to optimize performance, a user would direct its personnel to know what is expected of them, how they are to do it and what the personal benefits are for that new performance. Along the way, continuous personal feedback and reinforcement are needed if performance is to improve over time. In order to provide this feedback and reinforcement, a sales and recognition building module 228 (such as eMaritz supplied by Maritz Inc.) may be used.

By incorporating some or all functionality of a sales and recognition building module 228 into the system of the invention, users are able to easily build, customize and implement sales contests, training reinforcement or recognition programs on-line. Fully web-enabled solutions provide program ideas, recommendations and a wide variety of themes and communications, complete with administrative tools and a flexible award selection. In addition, a custom extra net gateway may serve as an access point for users and their employees to not only track their own initiatives but also to link business-sponsored programs as well. Thus far, the various components from the diagnostics module 212 to the awards program implemented by the sales and recognition building module 228 have been described.

The customer retention module 232 may be an additional aspect of the invention. The following illustrates the four aspects of an exemplary web page for the customer retention module 232.

Customer Prospect Manager

Find your customers who are most likely to purchase a vehicle from your dealership in the next six months

At Risk Customers

Find your customers who are most likely to defect to another dealership, brand, etc.

Customers Based on Loyalty Model

Find your most loyal customers

Find Customers

Find customers by Time Period, Salesperson, Question, and Response

The web page includes links to a customer prospect manager application, a list of at-risk customers, a list of customers based on loyalty modeling, and a tool that allows the user to find specific customers.

Throughout the entire customer satisfaction and performance measuring process of the invention there is one common denominator that ties the system together, and that is the customer. While the system and method of the invention primarily focuses on feedback from the customer, there may also be a need to simultaneously, proactively contact the customer. This is the purpose of the customer retention module (such as Vault or eVault provided by Maritz Inc.) and the related marketing activities 234. This contact can be anything from sending a postcard to customers thanking them for their recent purchase all the way to analyzing customer transaction and financial information to identify highly valued customers. Depending on the available customer data, such as sales data, service data and buyer behavior data, a user can identify those customers, and similar customers, who are likely to re-purchase from the business of the user and, most importantly, those customers, and similar customers, they are likely to lose. The customer retention module 232 assists the user in maintaining and improving communications with the customers.

In summary, the above is an overview of the system and method according to the invention that integrates the core business services relating to HCSI data into one easily accessible web site portal that manages the customer satisfaction, performance measurement, and performance improvement process through a diagnostics module 212, a research module 216, a procedure module 220, a training module 224, a sales and recognition builder module 228 and a customer retention module 232. The method and system of the invention constitute a powerful web-based tool set which assists users in reaching success in their business by understanding, implementing and managing the business at the retail level.

Walk Through of an Automotive Dealer System

The following example illustrates the invention, with reference to FIG. 1A.

In one embodiment, the user is an automotive dealer and the CSI data relates to customer satisfaction following the sale or servicing of an automobile. One example of how an automotive dealer would use the system 100 is now described.

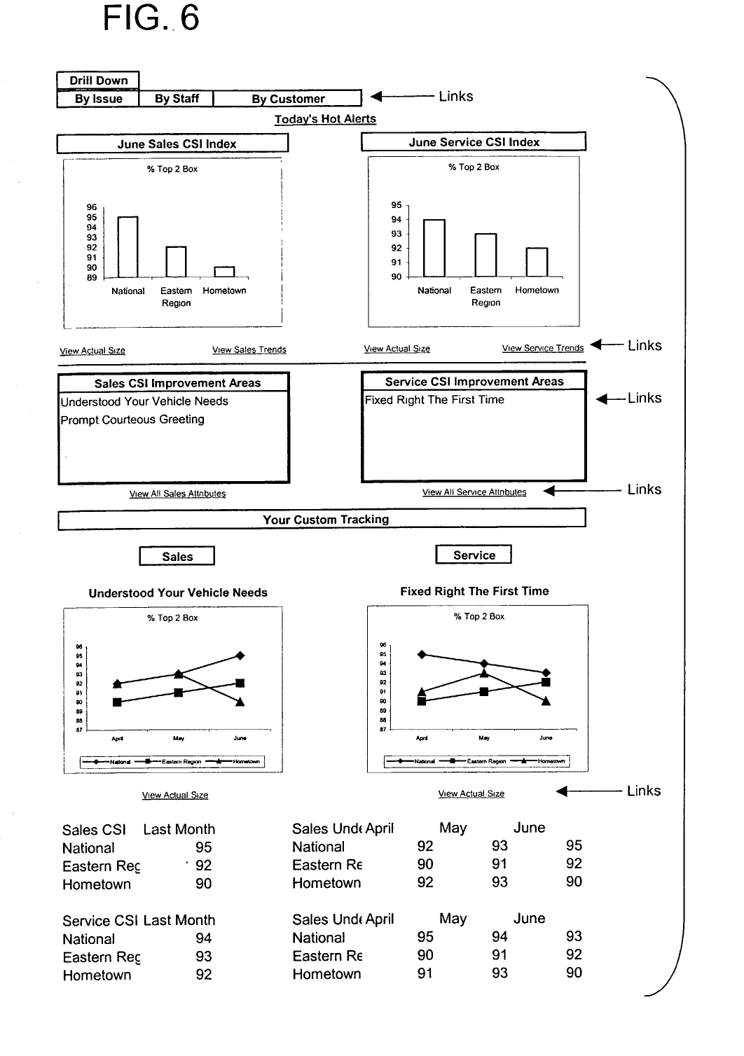

FIG. 6 illustrates a screen shot of the information (see FIG. 1A, reference character 1002) provided to the dealer by the diagnostics module 212. Such information may include alerts, sales CSI index and service CSI index on a monthly basis, sales CSI improvement areas, service CSI improvement areas and custom tracking (see FIG. 1A, reference character 1006). As illustrated in FIG. 10, the custom tracking allows users to define what is seen on the home page. In this case, it includes charts illustrating the number of sales people who understood particular needs and the number of service people that fixed the problem correctly the first time.

The dealer starts at their customized Homepage (FIG. 6) of the Diagnostics Module 212. This page provides top-level CSI results, Performance Improvement Planners, and Customized Tracking Charts. From here, the dealer can drill down into the data from the top-level reports; drill into the data on an issue, staff, or customer-level basis; or go directly to the top level of any other module within the system. In this example, the dealer chooses to look more closely at staff-level data by clicking on the Drill down by Staff button (see FIG. 1A, reference character 1002).

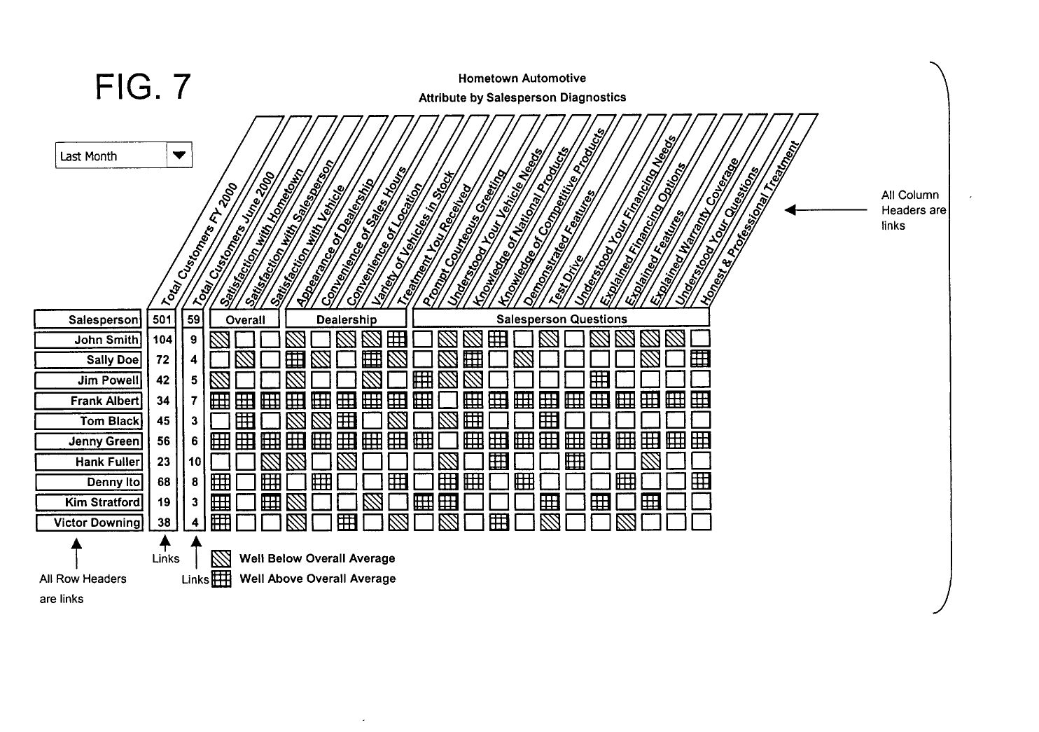

This takes the dealer to a summary chart (FIG. 7)(see FIG. 1A, reference character 1008) comparing each salesperson's scores to the average score for that section of the CSI questionnaire or other survey. By reading across the chart, the dealer can easily determine who is performing well (in this case, Frank Albert and Jenny Green) and who is in need of improvement (in this case, John Smith). By reading down the chart, the dealer can identify issues which salespeople need to work on (in this case, Understanding Your Vehicle Needs) and where they are performing well. From here, the dealer can click on a salesperson's name (see FIG. 1A, reference character 1002) to view a chart of how that salesperson is performing on all the attributes, click on an attribute to see how all salespeople are performing on that attribute (see FIG. 1A, reference character 1002), or view customer-level responses by clicking on the Customers link (see FIG. 1A, reference character 1002). In this case the dealer clicks on the Understood Your Customer Needs link (see FIG. 1A, reference character 1002) because this appears to be an area in need of improvement. In one embodiment, the chart displays the dealership averages and the national averages for each attribute.

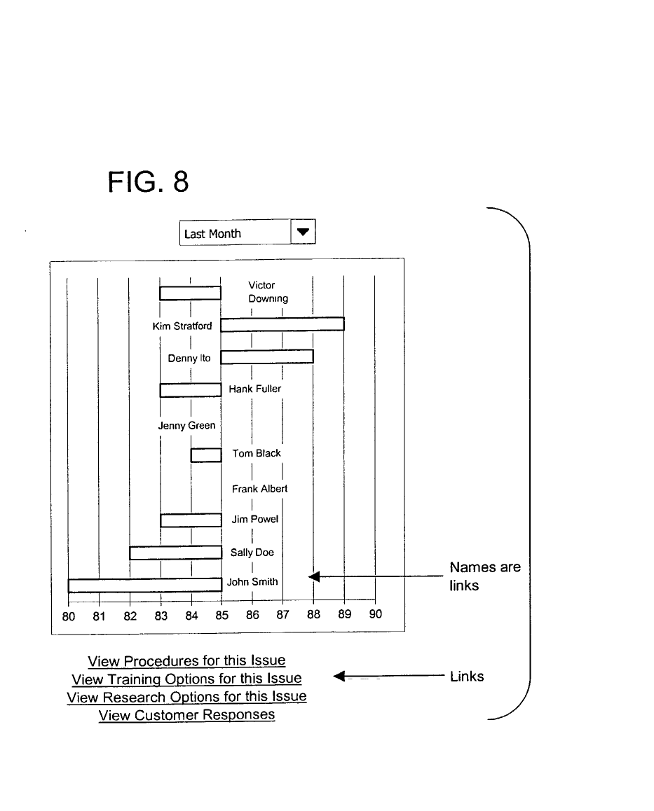

This brings the dealer to a page (FIG. 8) (see FIG. 1A, reference character 1008) showing each salesperson's score, compared to the dealership mean, for the attribute Understood Your Vehicle Needs. From viewing this chart, the dealer can see that John Smith is having the most difficulty understanding his customers' needs. From here, the dealer can directly access on-line manufacturer retail procedures or training options specifically addressing this issue, or the dealer can look into this issue further. In this example, the dealer chooses to look at John's average scores for this issue over the past year by clicking on his name in the chart (see FIG. 1A, reference character 1002).

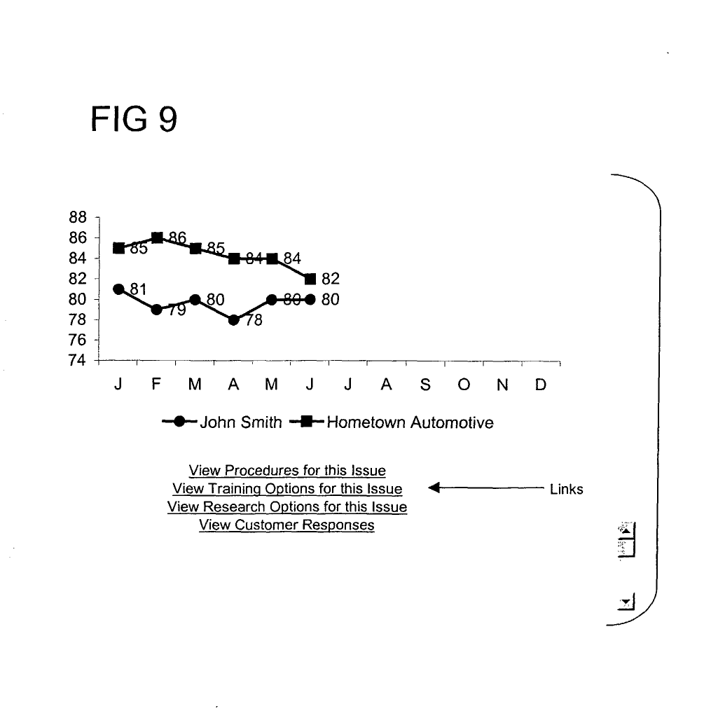

This chart (FIG. 9) clearly indicates that John Smith, when compared to the dealership as a whole, has been consistently below average for this issue for an extended period of time. From here, the dealer can again view retail procedures (see FIG. 1A, reference character 1012) or training (see FIG. 1A, reference character 1014) for this issue, view John's customer responses or gather information from John's customers by linking to the Research Module (see FIG. 1A, reference character 1004). In this example, the dealer chooses to view customer responses (see FIG. 1A, reference character 1002).

This page (FIG. 10) shows John Smith's customers' responses for the time period under consideration. This chart (see FIG. 1A, reference character 1008) can be used to determine if one or two customers are strongly influencing John's scores. In this case, it appears that customers are generally in agreement when rating John's performance, and that he has problems understanding their needs. Again, the dealer has a variety of options available regarding what to do next. In this example, the dealer chooses to click on the View Customer Comments link (see FIG. 1A, reference character 1002) to gain more information about John's performance.

The following report helps dealers understand issues by viewing comments customers made when describing their buying experiences.

| Customer | Attribute | Customer Comments |
|---|---|---|
| Larry Jones | Understood your | My salesman kept trying to show me |
| | Vehicle Needs | compact cars. I asked to see large |
| | | to luxury cars because I'm so tall, I |
| | | would be able to fit in a compact |
| | | car. It seemed that he wasted a lot |
| | | of my time looking at cars I couldn't |
| | | fit into. |
| Uma Pearson | Prompt & Courteous | I stood around the lot for more than |
| | Greeting | 15 minutes before a salesperson came |
| | | out to help me. |

This page also allows dealers to view the actual image of the survey by clicking on the customer's name (see FIG. 1A, reference character 1002).

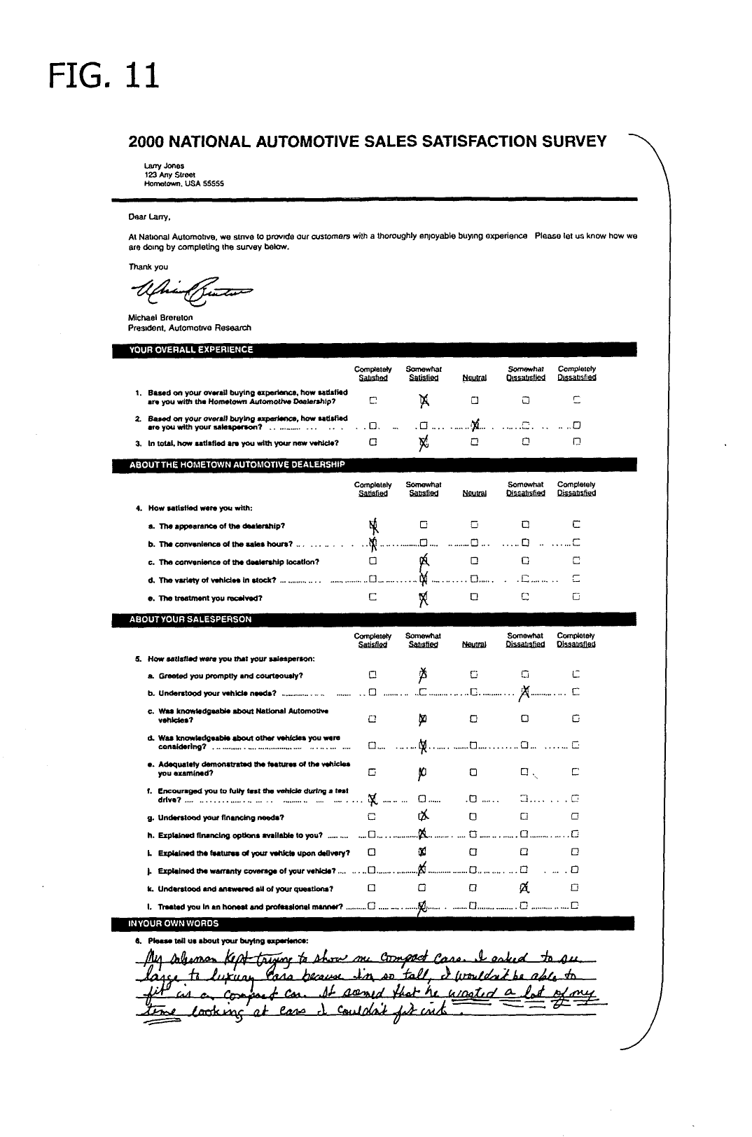

Since most CSI surveys are scanned during the data entry process, actual survey images (FIG. 11) (see FIG. 1A, reference character 1008) are available to automotive dealers on-line. This allows dealers to get a better feel for the customer by looking at how the customer filled out the questionnaire and by seeing comments written in the margins. In this case, as indicated in the comment section, the respondent seems particularly upset that John wasted his time. The survey images represent the most detailed information available in the system. At this point, the dealer may go back a few steps to John's trend chart (FIG. 9) and see how a dealer might have branched off in a different direction from there.

As you may recall, this page (FIG. 9) shows John Smith's scores for this year for the attribute Understood Your Vehicle Needs. Previously, the dealer chose to drill down into John's customers' responses. Alternatively, the dealer could have decided to collect more information by clicking on the View Research Options For This Issue link (see FIG. 1A, reference character 1004). This link brings the dealer to the Research Module (216).

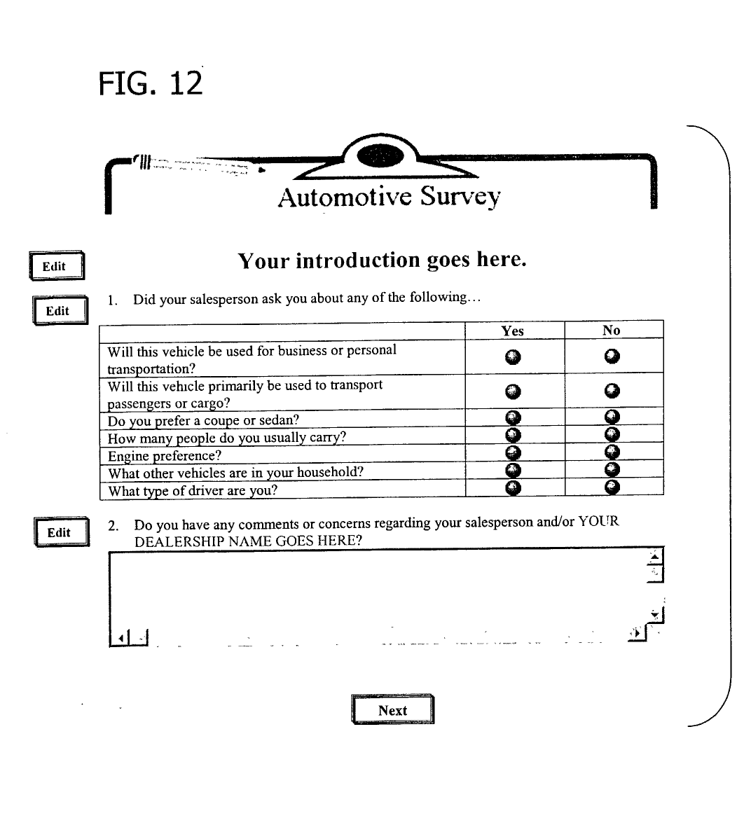

Through the use of resource mapping (see FIG. 1A, reference character 1016), this link accesses the appropriate survey content (see FIG. 1A, reference character 1018) and takes the dealer directly to a survey template (FIG. 12) (see FIG. 1A, reference character 1024) within the Research Module which is customized to assess issues surrounding Understanding Your Customer Needs. The questions for this survey template are based off of the Procedures and Training related to this issue which are contained in other modules within the system. If no survey template had been available, the dealer would have been brought to the next-higher level within the Research Module. This level would list survey templates addressing a variety of topics from which the dealer could choose. As can be seen in this example, when using a template the dealer can easily customize each survey question by clicking on its associated Edit button. In this example the dealer clicks the Edit button for Question Two (see FIG. 1A, reference character 1004).

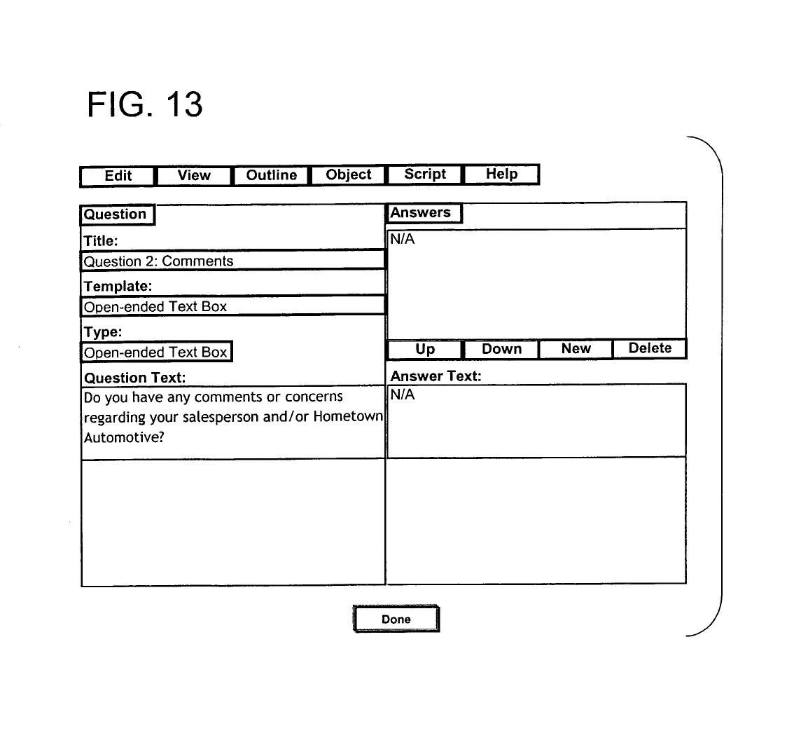

This page (FIG. 13) (see FIG. 1A, reference character 1024) allows the dealer to customize each question. The dealer can change the question contents, choose the type of response choice (For example—single answer, multiple answer, or open-ended text box), and enter labels for multiple choice answers. After completing the modifications, the dealer clicks on the Done button (see FIG. 1A, reference character 1004) and is brought back to the survey in its modified form (see FIG. 1A, reference character 1024).

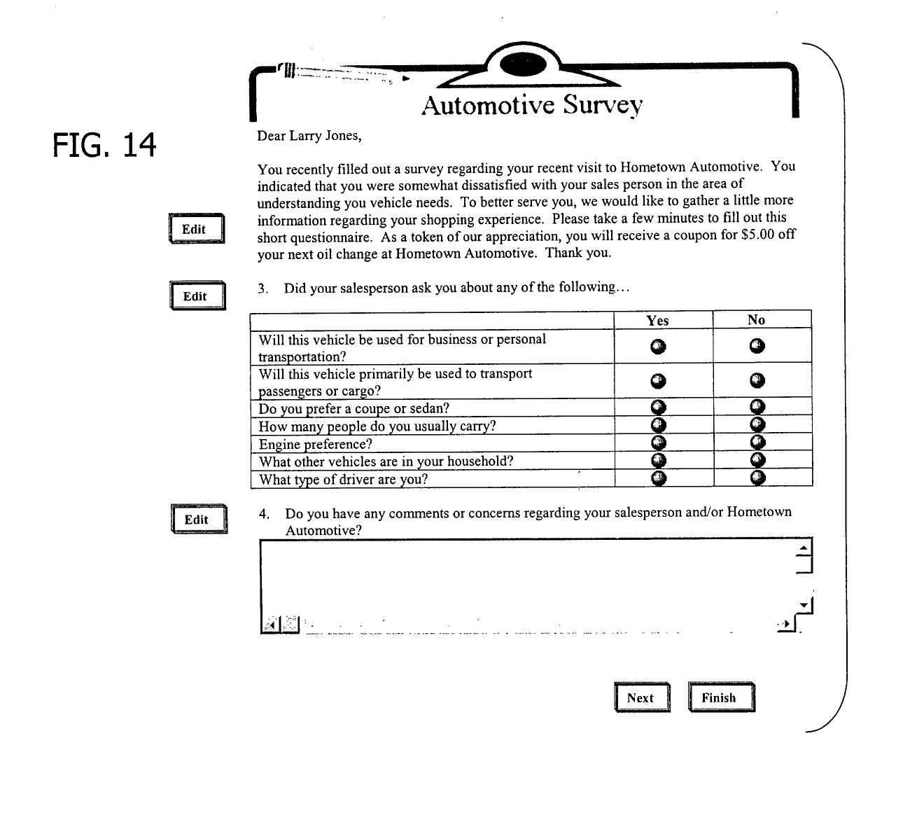

On this page (FIG. 14), the dealer can choose to either further edit the survey or accept it as it is. In this example, the dealer chooses to accept the survey and post it on the server by clicking the Finish Button (see FIG. 1A, reference character 1004).

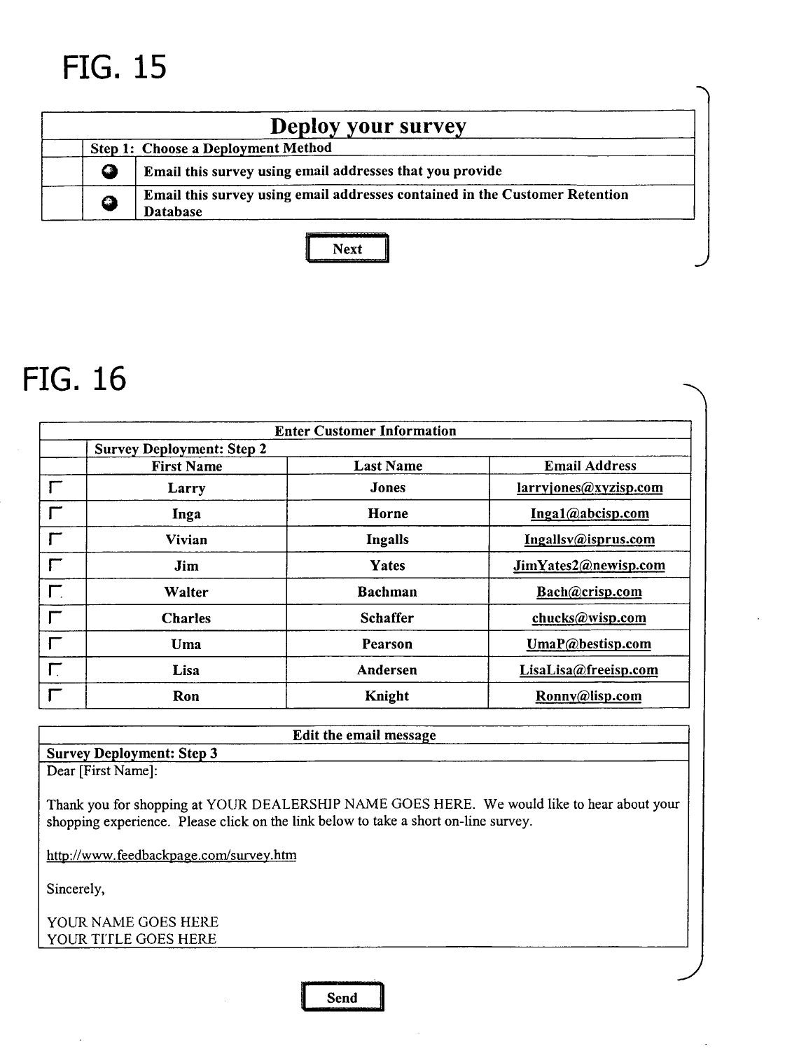

After developing the survey, the dealer is brought to the deployment section of the Research Module 216 (see FIG. 1A, reference character 1004). This page (FIG. 15) (see FIG. 1A, reference character 1024) shows options available to the dealer to deploy the survey. In its initial phase, the system will offer e-mail survey deployment only. However, Maritz Research has extensive telephone and mail data capture capabilities which will be linked to the system in the future. In this example, the dealer chooses to deploy the survey using dealer supplied e-mail addresses by clicking on its associated button (1004).

Next, the dealer is taken to a page (FIG. 16) (see FIG. 1A, reference character 1024) to enter customer information for the e-mail survey invitation which will be sent to potential respondents. After entering the information, the dealer edits the text of the e-mail message. When complete, the dealer clicks on the Send button (see FIG. 1A, reference character 1004). This button generates a customized e-mail to potential survey respondents, with a message asking them to take the survey by clicking on the enclosed link (see FIG. 1A, reference character 1024).

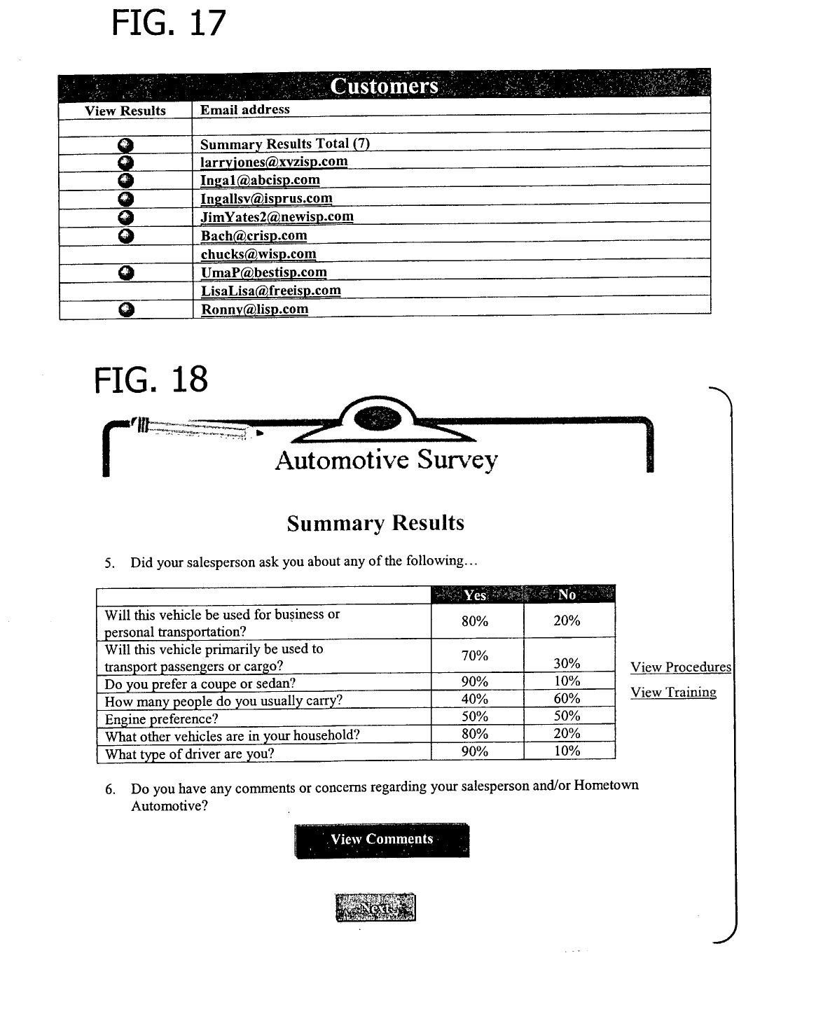

After deployment, the dealer will want to look at the results of the survey. This page (FIG. 17) (see FIG. 1A, reference character 1024) illustrates how a dealer can determine who has responded, and view summarized or individual results of the survey (see FIG. 1A, reference character 1042). In this example, the dealer chooses to view summary results by clicking on its associated button (see FIG. 1A, reference character 1004).

This page (FIG. 18) (see FIG. 1A, reference character 1026) shows up-to-the-minute summarized survey results in an easy-to-read format. To make survey results more actionable, wherever possible, links to corresponding retail procedures (see FIG. 1A, reference character 1012) and training courses are included (see FIG. 1A, reference character 1014). In this example, after reviewing the results of the survey the dealer chooses to look at the Manufacturer Retail Procedures for this issue by clicking on the View Procedures link (see FIG. 1A, reference character 1012).

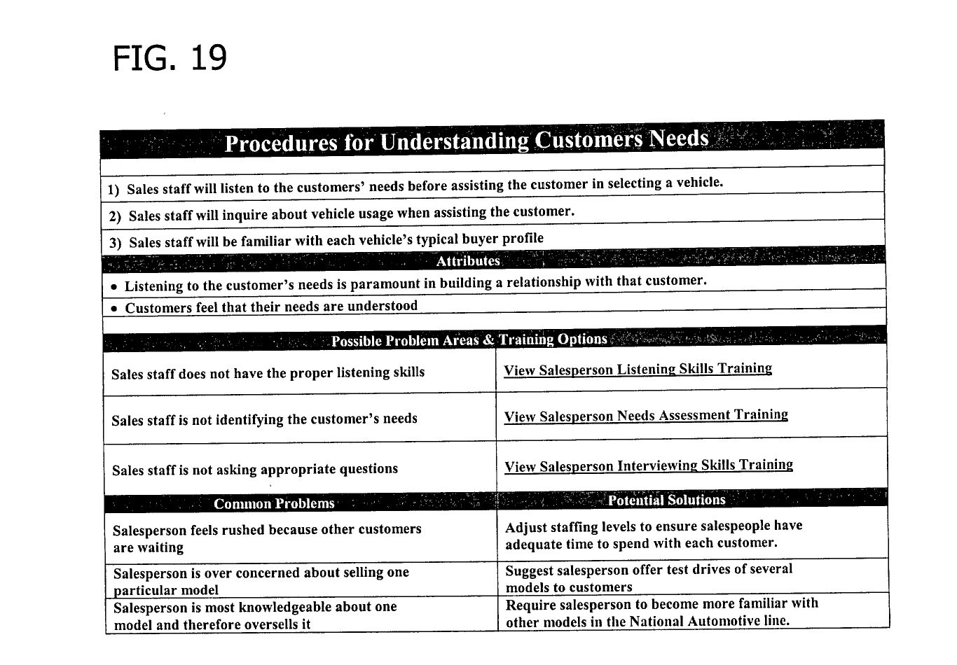

Through the use of resource mapping (see FIG. 1A, reference character 1016), this link brings the dealer to the manufacturer retail operating procedure (FIG. 19) contained in the Procedures Library 220 which is associated with Understanding Customer Needs. Here, the dealer can see what processes and behaviors are suggested by the manufacturer to help salespeople understand their customers' needs. To make this information more actionable, this section can also contain Common Problems and Common Solutions associated with the issue under consideration. Links to manufacturer training (see FIG. 1A, reference character 1014) associated with the issue are also provided. In this example, the dealer has determined that John Smith may not be asking the right questions of his customers. Therefore, the dealer clicks on the View Salesperson Interviewing Skills Training link (see FIG. 1A, reference character 1014) to see if John has completed this training.

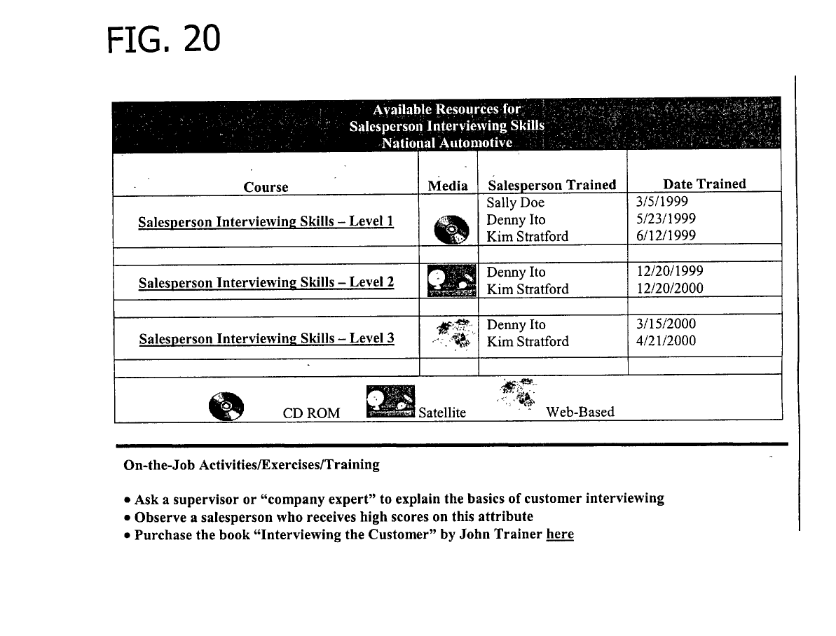

Once the Interviewing Skills link is clicked, it navigates the dealer to the Training Module 224 at a level directly associated with Interviewing Skills. By reviewing this page (FIG. 20) (see FIG. 1A, reference character 1032), the dealer can determine what training is available, what media is used to deliver the training, and which salespeople have participated in training. In this example, the dealer notices that John Smith has not completed any interviewing training. Therefore, the dealer begins to enroll John in the Salesperson Interviewing Skills B Level 1 training by clicking on its associated link (see FIG. 1A, reference character 1014).

Next, the dealer sees the following overview (see FIG. 1A, reference character 1028) of the course selected.

Course Detail
Salesperson Interviewing Skills-Level 1

| | |
|---|---|
| Level: | Orientation |
| Description: | This course educates the student about the |
| | basics in interviewing the customer |
| Media: | CD ROM |
| Length: | 1 hour 20 minutes |
| Curriculum: | Interviewing Skills |
| Audience: | All New Employees |
| Objectives: | Prepare the student to ask the right questions |
| | to assess customers' needs when assisting them |
| | in selecting the appropriate vehicle. |
| Cost: | $200.00 (Reusable) |

This provides the dealer with the information needed when deciding if a training course is appropriate for an employee. Upon reviewing this information, the dealer in this example decides to register John for the training by clicking on the Register for this class link (see FIG. 1A, reference character 1014).

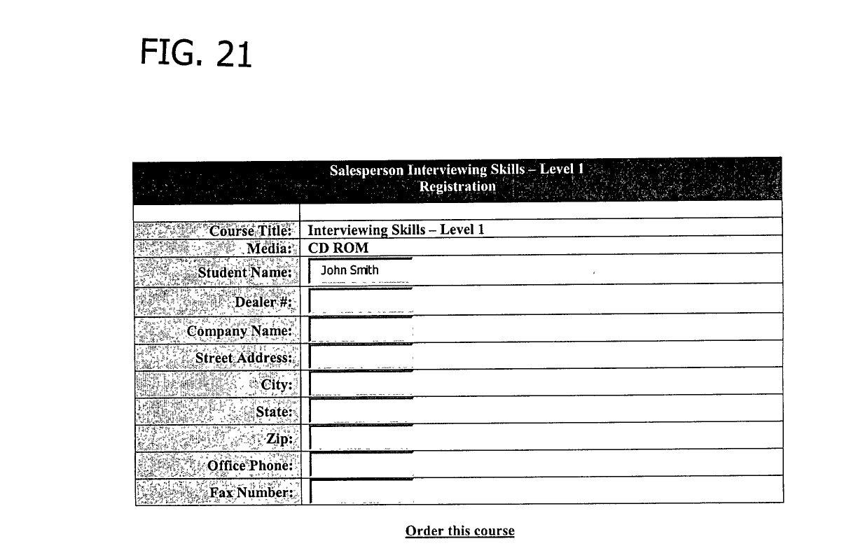

This registration page (FIG. 21) (see FIG. 1A, reference character 1028) shows a typical enrollment form where the dealer enters vital information and orders the course. Through the system, training courses can be delivered, employees can be tested for comprehension, and training results can be tracked by the dealer—all online. For offline training courses which are CD- or paper-based, fulfillment capabilities which can be utilized. Furthermore, online assessment of information learned in offline training can be incorporated in the system. In addition, all training programs can be linked to recognition programs as an incentive for successfully completing the course. Programs can also be set up to increase sales. The Sales and Recognition Builder 228 (see FIG. 1A, reference character 1034) connects dealers to eMaritz. eMaritz is an innovative new service that enables automotive dealers and other medium and small-sized businesses to build, customize, and implement sales contests, training reinforcement, and recognition programs. These services are all provided on-line.

In addition to using Customer Information as the foundation for assessing staff and dealership performance, and finding areas in need of improvement, CSI information can often be used on a respondent-level basis for dealership customer retention activities (234). If a CSI program is designed to track customers longitudinally, models can be developed predicting customers who are likely to re-purchase within a given time period, customers who are loyal to the dealership and brand, and customers likely to be lost (see FIG. 1A, reference character 1038).

At Risk Customers Report
Sales customers who have not come in
for service within six months of purchase

| Customer Name | Address | Phone | Salesperson |
|---|---|---|---|
| Sally Thompson | 123 Main | 555-1212 | John Smith |
| | Hometown, USA | | |
| George | 456 Elm | 55-1234 | John Smith |
| Winningham | Hometown, USA | | |
| Scott Yark | 789 Oak | 555-1000 | Sally Doe |
| | Hometown, USA | | |

Service Customers who have not come in
For service within six months

| Customer Name | Address | Phone | Sales Manager |
|---|---|---|---|
| Kevin Richards | 123 Main | 555-1212 | Bill Tillis |
| | Hometown, USA | | |

Service customers whose warranties
Expire in the next two months

| Customer Name | Address | Phone | Sales Manager |
|---|---|---|---|
| Randy Schwartz | 123 Main | 555-1212 | Bill Tillis |
| | Hometown, USA | | |
| Lisa Harris | 456 Elm | 555-1234 | Bill Tillis |
| | Hometown, USA | | |

In the Customer Retention Module 232, dealers can easily find their customers who fall into these categories so they can take action if necessary. Dealers can also perform custom searches to find customers based on practically any attribute measured in the CSI questionnaire. For this example, let's assume the dealer wants to find customers who may defect from the dealership. This is done by clicking on the At Risk Customers button (see FIG. 1A, reference character 1036).

The At Risk Customers report (FIG. 29) (see FIG. 1A, reference character 1038) lists customers who meet criteria which, through statistical analyses, have been found to be associated with defecting from the dealership. The dealer can then contact these customers and attempt to maintain their patronage. Now let's go back to the Customer Retention Module 232 Homepage to see how a dealer might perform a customized search of customers. From here, the dealer selects the Find Customers button (see FIG. 1A, reference character 1036).

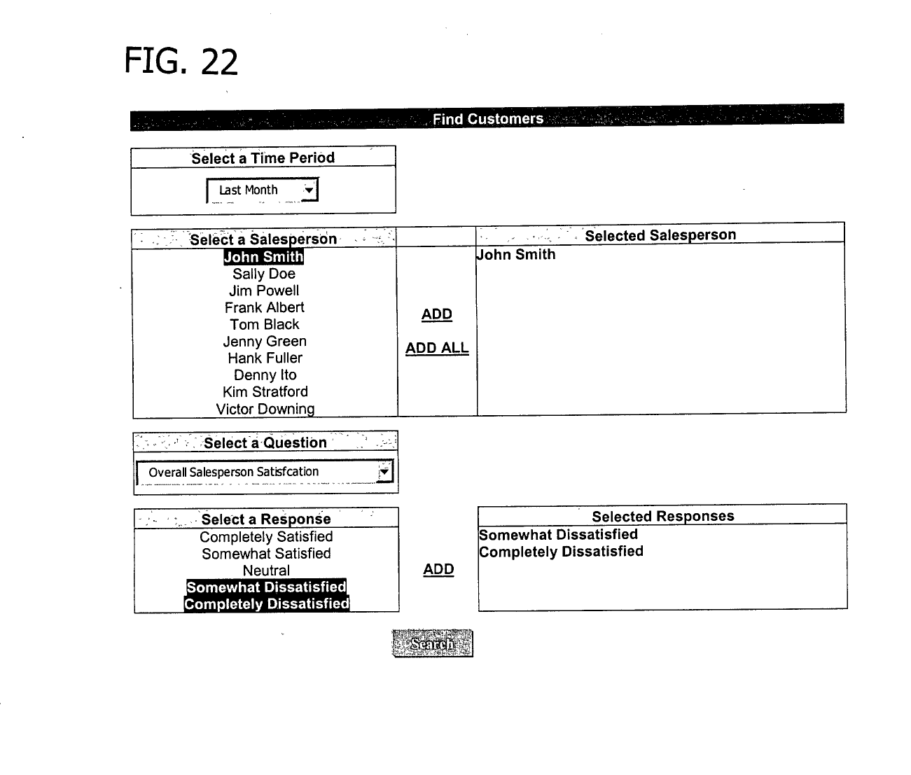

On this page (FIG. 22) (see FIG. 1A, reference character 1038), the dealer can set search criteria. In this case, the dealer is searching for last month's customers who had John Smith as a salesperson and responded Somewhat or Completely Dissatisfied to the Overall Salesperson question (202). After setting the criteria, the dealer clicks on the Search button (see FIG. 1A, reference character 1036).

The following page (see FIG. 1A, reference character 1040) represents the results of the dealer's search.

Customers Responding Completely Dissatisfied
or Somewhat Dissatisfied to Overall Salesperson
Satisfaction for Last Month

| Customer Name | Address | Phone | Salesperson |
|---|---|---|---|
| Hartley Miller | 123 Main | 555-1212 | John Smith |
| | Hometown, USA | | |
| James Ronald | 456 Elm | 555-1234 | John Smith |
| | Hometown, USA | | |
| Wally Underwood | 789 Oak | 555-1000 | Sally Doe |
| | Hometown, USA | | |
| Amy Presley | 741 Summit | 555-1111 | Hank Fuller |
| | Hometown, USA | | |

This information can be used to contact customers and rectify any problems before the customer decides to leave the dealership. This concludes this example walk-through of how a dealer uses the system and method of the invention.

Within the diagnostic tool 112, the system 100 provides the user with the ability to drill down from within reports by including multiple links within each report. In one embodiment, the reports include charts displaying the selected CSI data. The diagnostic application program automatically detects the number of questions which need to be displayed. These questions can be customized per each implementation of the system 100. As such, the report templates are not hard coded with question text. The diagnostic application program inserts question text into report templates.

In one embodiment, the diagnostic application program automatically detects the number of staff people per dealership and inserts the appropriate data into the report templates. This feature accounts for staff people that have joined or left the organization. In addition, the diagnostic application program retrieves data for a selected time frame and inserts such data into the report templates. For example, the selected time frame may include one month, three months, or twelve months. The user may select the time frame by using a pull-down menu in a graphical user interface. In one embodiment, default reports available from a diagnostic home page include reports for both sales and service with the choice of using one month, three month, or twelve month data.

Other reports available for selection by the user in the automotive embodiment include dealer-level improvement planners. These planners include reports that highlight what a dealer should do to improve the overall CSI score. In particular, these reports include a Performance by Importance chart summarizing data over one month, three month, or 12 month intervals. In addition, a Dealer Score Card report compares a particular dealer's scores against that dealer's scores over the last month, the last 3 months, and the last 12 months. In one embodiment, the comparison lists the five areas of most progress and the five areas of most regression with respect to CSI scores. Further, each dealer can produce similarly designed score cards for each sales/service person in the dealership.

The diagnostic application program offers staff-level tornado comparison charts for selection by the dealer. The dealer chooses questions and produces charts comparing staff members to the dealer's average score for that question. The reports include the ability to choose different time frames. In addition, the user can customize the chart selection by selecting the charts that are to be displayed to the user each month with the most recent CSI data. The user can also drill down to view the customer-level data driving the staff's scores.

The diagnostic program includes a Staff-Level Improvement Planner that displays a prioritization report for each salesperson or serviceperson. For each staff member, the reports isolate what the staff member needs to work on most. In addition, a Staff Improvement Area report highlights the staff members who are below the dealer average on each question. Similarly, a Staff Peak Performers report highlights staff members who score above the dealer average on each question. For these reports, the user can drill down to the customer-level data or make comparisons over one month, three months, or twelve months selected via pull-down menus. A Fixed Right First Time by Service Person by Service Code report details the frequency that a problem was fixed right the first time by a specific service staff member, organized by service codes used by the dealership. The user can also drill down to the customer-level data. The diagnostic application program also offers a Dissatisfied Customer report which allows users to choose questions and view customer-level data sorted to isolate dissatisfied customers. These reports provide the ability to drill down to view customer-level data and actual images of the surveys. The reports also provide the ability to do searches on customer verbatims for diagnostic purposes via code-based and text based queries. The data can be filtered by staff, time-frame, etc. The diagnostic application program also offers the ability to make custom trend graphs based on any question comparing the particular dealership to higher levels in the hierarchy (e.g., regional or national).

In one embodiment, the reports include various links to other on-line resources facilitate performance improvements based on CSI data. For example, the reports may include links to training for the specific problem, training tracking, procedures, awards to set up programs for awarding top performers, motivation programs for enrollment, further research to collect more information, and direct marketing to follow-up with unsatisfied customers.

While the examples of the system 100 described herein use network accessible web pages, those skilled in the art will note that some or all of the system 100 is applicable in a variety of embodiments including, but not limited to, a series of reports accessible via database or spreadsheet application programs. In addition, those skilled in the art will note that the database accessed by the system 100 is not necessarily included in system 100, but may be provided and maintained by a third party supplier. Further, some or all the modules may be part of the system 100, or they may be supplied by a third party as long as the system 100 has access to or receives data from the modules.

In one embodiment, the queries of the system 100 are dynamically built using session variables. When a user signs onto a web page embodying the system 100, a base set of default session variables are set to identify the user at a client determined level (i.e. National, regional, local). The session variables include, but are not limited to, a selected time period, a selected hierarchy level, a dealer identifier, a customer identifier, a user identifier, and a sales/service identifier.

The home page includes predetermined queries to maintain the portal consistency (i.e. users see the same familiar format each time they log on). From the home page, depending on what is chosen and depending on what level the user is at within the system, a structured query language (SQL) statement is built dynamically to produce a query that will return the desired results.

The SQL statements mentioned above have a set base of information to pull from the database. In one embodiment, it is mostly the SQL WHERE clause that is dynamically built depending on the level the user is at in the system and what information they are seeking. However, database table naming conventions and field naming conventions allow for dynamic table referencing (i.e. X_Sales_Current vs X_Service_Current B can be defined as X_somevariablename_Current and users can dynamically change somevariablename to anything/any related table naming convention by substituting the variable name with the appropriate information).

Once the queries have retrieved the desired data, a script is initiated that runs an algorithm which calculates the difference of the dbVar10 fields for each matching record on the dbVar3 and dbVar5 fields and then sorted in descending order and coded to highlight strengths and weaknesses. The results of this routine are then presented in a graphical format. The following is an example of an Active Server Page (ASP) page that dynamically builds the SQL statement. The top level ASP includes the following:

SQL=_select dbvar1,_& timeperiod &_, dbVar2, dbVar3 from

TablePrefix1_&studydb&_&dbtable&_TableSufffix1 inner join

TablePrefix1_&studydb&_&dbtable&_TableSufffix2 on

TablePrefix1_&studydb&_&dbtable&_TableSufffix1.dbvar4=

TablePrefix1_&studydb&_&dbtable&_TableSufffix2.dbvar4 inner join

LookupTable on TablePrefix1_&studydb&_&dbtable&_TableSufffix2.dbVar5=

LookupTable.dbVar3_&_{—}

_WHERE dbVar5 in (_&meanquestions&_)_&_{—}

_and dbVar6=‘_& nationalsumlevel &_’ and dbVar7=‘’_

if session(_Var8_)<>_{—}0_then

SQL=SQL+_and dbVar8=‘_&session(_Var8_)&_’_{—}

else

SQL=SQL+_and dbVar8=‘98’_{—}

end if

SQL=SQL+_order by dbVar3_{—}

The bottom level ASP includes the following:

SQL=_select dbvar1, t1._& timeperiod &_, dbVar2, t1.dbVar5, t2._& timeperiod &_as samplesize from

TablePrefix1_&studydb&_&dbtable&_TableSufffix1 inner join

TablePrefix1_&studydb&_&dbtable&_TableSufffix2 t1 on

TablePrefix1_&studydb&_&dbtable&_TableSufffix1.dbVar4=t1.dbVar4 join

TablePrefix1_&studydb&_&dbtable&_TableSufffix2 t2 on

TablePrefix1_&studydb&_&dbtable&_TableSufffix1.dbVar4=t2.dbVar4 left join LookupTable on t1.dbVar5=LookupTable.dbVar3_&_{—}

_WHERE t1.dbVar5 in (_&meanquestions&_)_&_{—}

_and t2.dbVar5=‘_& returns &_’_&_{—}

_AND dbVar9=‘_& session(_Var9_) &_’_&_{—}

_and dbVar6=‘_& dealersumlevel &_’ and dbVar7=‘’_{—}

if session(_dbvar8_)<>_{—}0_then

SQL=SQL+_and dbVar8=‘_&session(_Var8_)&_’_{—}

end if

SQL=SQL+_order by t1.dbVar5_{—}

The top level SQL statement that results from the top level ASP above is as follows:

select dbvar1, dbVar10, dbVar2, dbVar3 from

TablePrefix1_Sales_current_TableSufffix1 inner join

TablePrefix1_Sales_current_TableSufffix2 on

TablePrefix1_Sales_current_TableSufffix1.dbVar4=

TablePrefix1_Sales_current_TableSufffix2.dbVar4 inner join LookupTable on

TablePrefix1_Sales_current_TableSufffix2.dbVar5=LookupTable.dbVar3 WHERE

dbVar5 in (>01=,=02=,=03=,=04=,=05=) and dbVar6=‘06’ and dbVar7=‘’ and

dbVar8=‘98’ order by dbvar3

The bottom Level SQL statement that results from the bottom level ASP above is as follows:

select dbvar1, t1.dbVar10, dbVar2, t1.dbVar5, t2.v_{—}3 as samplesize from

TablePrefix1_Sales_current_TableSufffix1 inner join

TablePrefix1_Sales_current_TableSufffix2 t1 on

TablePrefix1_Sales_current_TableSufffix1.dbVar4=t1.dbvar4 join

TablePrefix1_Sales_current_TableSufffix2 t2 on

TablePrefix1_Sales_current_TableSufffix1.dbVar4=t2.dbvar4 left join

LookupTable on t1.dbvar5=LookupTable.dbVar3 WHERE t1.dbVar5 in (>01=,=02=,=03=,=04=,=05=) and t2.dbVar5=‘06’ AND dbVar9=‘00001’ and

dbvar6=‘02’ and dbVar7=‘’ order by t1.dbVar5

Exemplary Embodiments

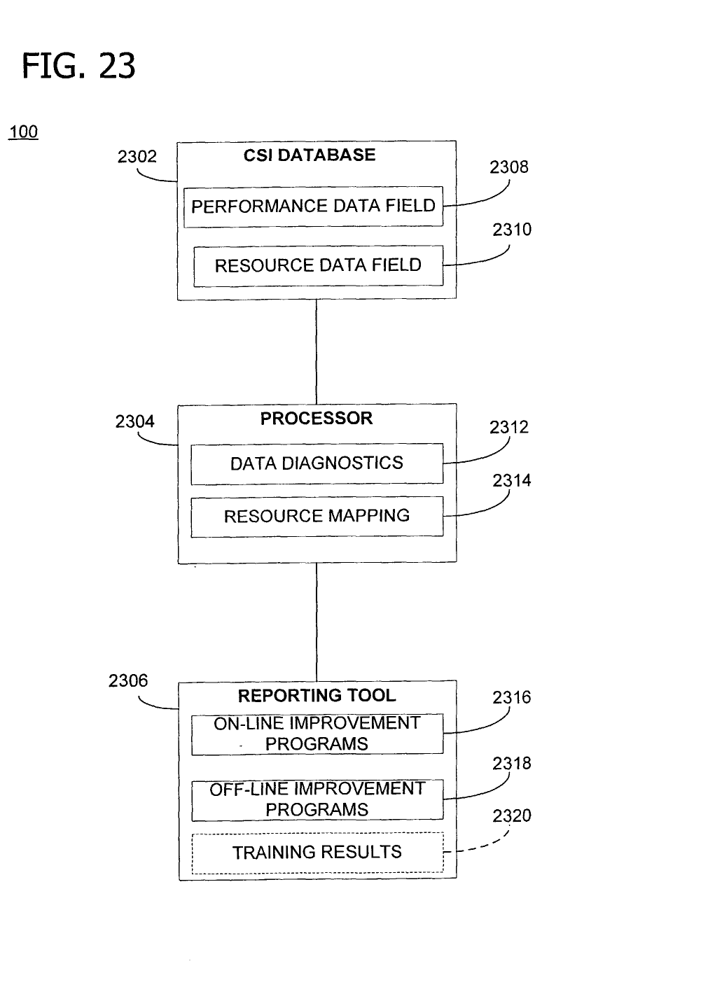

Referring next to FIG. 23, an exemplary block diagram illustrates the basic components of a system for implementing the invention. In this example, the basic components of the system 100 includes a CSI database 2302, a processor 2304, and a reporting tool 2306.

The CSI database 2302 contains a performance data field 2308 and a resource data field 2310, and is communicatively linked to processor 2304. The processor 2304 is configured to perform data diagnostics 2312 and resource mapping 2314, and is communicatively connected to reporting tool 2306. The reporting tool 2306 provides links to on-line and off-line improvement programs 2316, 2318 that help the user address satisfaction issues identified during data diagnostics 2312. In another embodiment, the reporting tool 2306 is further configured to provide training results 2320. For example, the reporting tool 2306 provides before and after performance data for employees and/or employers that have participated in a particular improvement program.

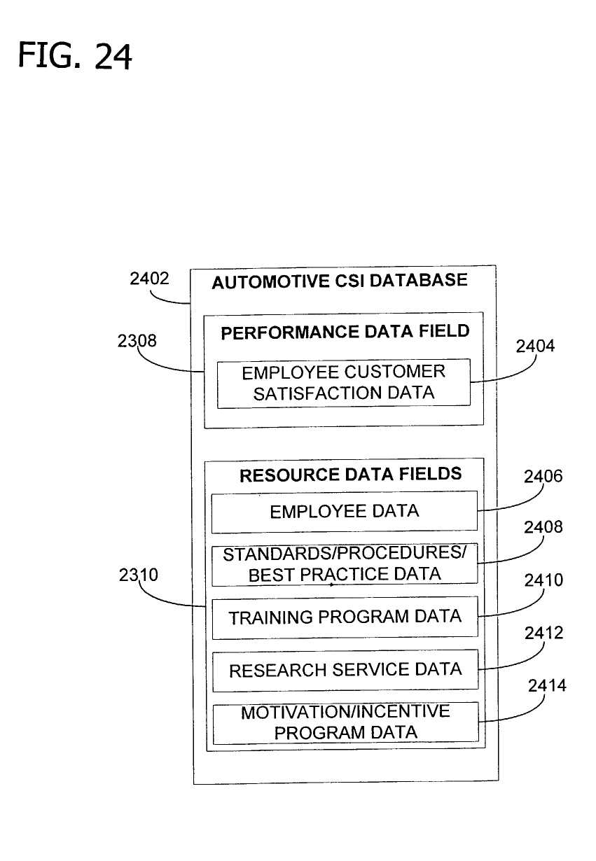

Referring next to FIG. 24, an exemplary block diagram illustrates the contents of an automotive CSI database that stores data relating to customer satisfaction issues in automotive transactions. The automotive CSI database 2402 has a performance data field 2308 and a resource data field 2310.

In such an embodiment, the performance data field 2408 contains employee customer satisfaction data 2404. The employee customer satisfaction data 2404 includes customer assessments of the services they received from employees during an automotive transaction with a dealer.

In this exemplary embodiment, the resource data field 2310 contains the following: employee data 2406; standards, procedures, and best practice data 2408; training program data 2410; research service data 2412; and/or motivation and incentive program data 2414. The employee data includes information acquired as a result of the employer-employee relationship. For example, the employee data 2406 may include years of service, attendance records, and customer complaints. The standards, procedures, and best practice data 2408 includes business procedures and/or retail operating procedures that provide guidelines or policies for addressing customer satisfaction issues. The training program data 2410 includes information about resources that can be used to assist one or more employees improve their performance. For example, the resource may be an on-line library that outlines a training program for improving customer satisfaction. The research service data 2412 enables the user to conduct directed on-line or other research directed to specific issues. The motivational and incentive program data 2414 includes information about reward or recognition systems designed to encourage employees to improve their performance as it relates to specific satisfaction issues.

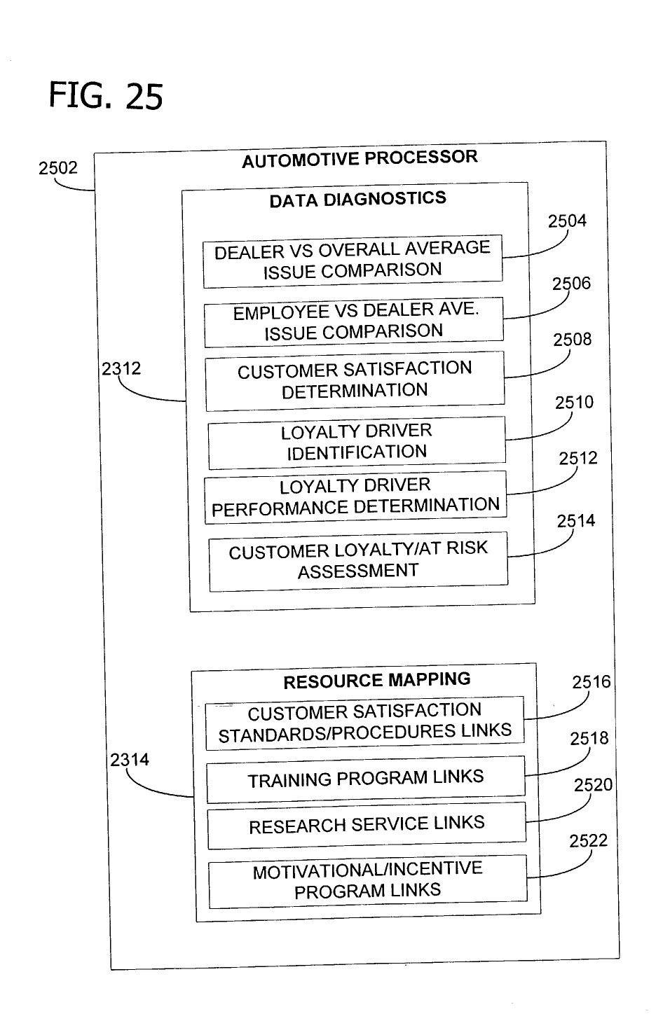

Referring next to FIG. 25, an exemplary block diagram illustrates the operations of an automotive processor that analyzes customer satisfaction issues in automotive transactions. The automotive processor 2502 performs data diagnostics 2312 and resource mapping 2314.

In this instance, the data diagnostics 2412 include the following: dealer vs. average issue comparison 2504; employee vs. dealer average issue comparison 2506; customer satisfaction determination 2508; loyalty driver identification 2510; loyalty driver performance determination 2512; and customer loyalty and/or customer at risk assessment 2514.

The dealer vs. average issue comparison 2504 compares the performance of a particular automotive dealer to an overall average performance for one or more customer satisfaction issues. The overall average can be determined by normalizing or averaging CSI data from multiple dealers. For example, the automotive processor employs an averaging algorithm to determine the overall average from district, local, regional or national automotive CSI data. The employee vs. dealer average issue comparison 2506 compares the performance of a particular employee to the average performance of the all the dealer's employees for one or more customer satisfaction issues.

Customer satisfaction determination 2508 determines whether the customer was satisfied with the service he or she received during a transaction with the dealer. One method of assessing customer satisfaction is through customer surveys. In such an embodiment, the automotive processor 2502 sorts the survey results (i.e., scores) against a user defined threshold value. A score above the threshold value indicates a satisfied customer, and a score below the threshold value indicates a dissatisfied customer. The threshold value may be defined by any method known to those skilled in the art. For example, the threshold value can be selected based on personal experience, or calculated through statistical analysis of automotive CSJ data. Moreover, the threshold value may be static, or an average (e.g., regional, national, or local).

Loyal customers are customers that have exhibited some form of devotion to the dealer. The devotion may be evidenced by previous transactions with the same dealer, or anticipated based on previous purchases of a product brand offered by the dealer. For example, the automotive processor 2502 identifies loyal customers by sorting the automotive CSI database 2402 for repeat customers, or by using statistical analysis of the automotive CSI data. Loyalty driver identification 2510 identifies issues that drive customer loyalty. The automotive processor 2502 determines loyalty drivers by sorting automotive CSI data and identifying satisfaction issues that are shared among identified loyal customers. For example, a satisfaction issue shared among loyal customers may be the appreciation of receiving a thank you letter or card from the dealer. Loyalty driver performance determination 2512 determines whether the dealer is performing the identified loyalty drivers by sorting the automotive CSI data against identified loyalty drivers. For example, automotive processor 2502 sorts automotive CSI data to determine whether customers report receiving thank you letters or cards from the dealer. The customer loyalty/at risk assessment 2514 identifies missed opportunities or at risk customers based on customers' CSI scores and their relationships to loyalty measures.

In this instance, the resource mapping 2314 includes the following: customer satisfaction standards/procedures links 2516, training program links 2518, research service links 2520, and motivational/incentive program links 2522. The customer satisfaction standards and/or customer satisfaction procedures links 2516 link the user to online business procedures and/or online retail operating procedures that provide guidelines for satisfying the customer. The training program links 2518 provide the user access to online information that assists employees or dealers improve their performance regarding customer satisfaction. The research service links 2520 enable the user to conduct directed on-line or other research directed to specific issues. The motivational and incentive program links 2522 direct the user to reward or recognition systems that encourage employees to improve their performance as it relates to specific issues.

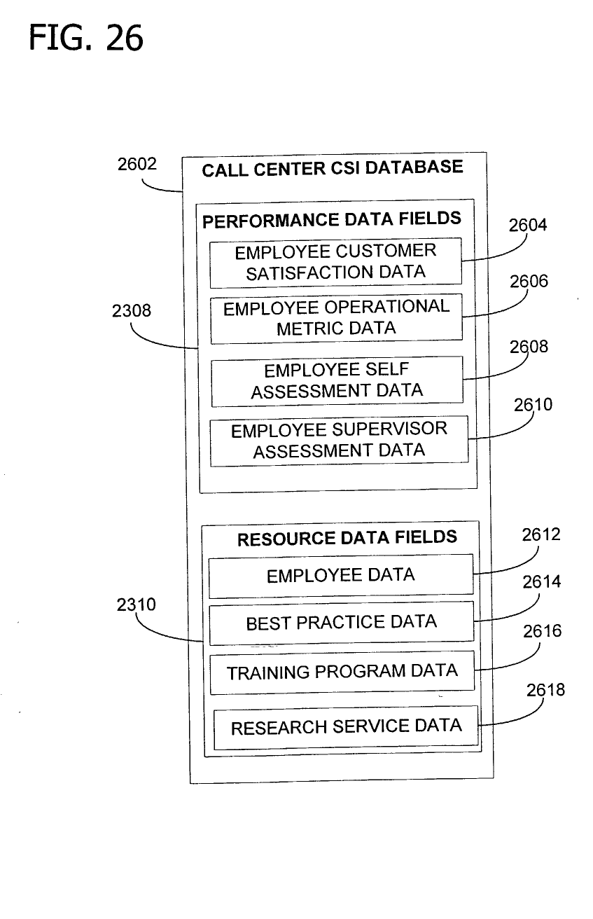

Referring next to FIG. 26, an exemplary block diagram illustrates the contents of a call center CSI database that stores data relating to customer satisfaction issues in call center transactions. The call center CSI database 2602 contains a performance data field 2308 and a resource data field 2310.

In this exemplary embodiment, the performance data field 2308 contains the following: employee customer satisfaction data 2604; employee operational metric data 2606; employee self assessment data 2608; and employee supervisor assessment data 2610. The employee customer satisfaction data 2604 includes customer assessments of the services they received from employees during a transaction with the call center. The employee operational metrics data 2606 includes objective information for evaluating the quality of the employee performance as it relates to customer satisfaction issues. Operational metrics are defined from historical information and provide a baseline for improving the employee's service delivery. Exemplary operation metrics include resolution of the issue during the first call, average time spent on calls, and average sales per call. The employee self assessment data 2608 includes the employee rating of his or her performance as it relates to customer satisfaction issues. The employee supervisor assessment data 2610 includes management's ranking of the employee's performance as it relates to customer satisfaction issues.

In this example, the resource data field 2310 includes employee data 2612; best practice data 2614; training program data 2616; and/or research service data 2618. The employee data 2612 includes information acquired as a result of the employer-employee relationship. For instance, employee data 2612 can include years of service, attendance records, and customer complaints. The best practice data 2614 includes business procedures and/or retail operating procedures that provide guidelines or policies for addressing customer satisfaction issues. The training program data 2616 includes resource information that can be used to assist one or more employees improve their customer service performance. For example, the resource may be an on-line library that outlines a training program for improving customer satisfaction. The research service data 2618 includes information about directed on-line or other research directed to specific issues.

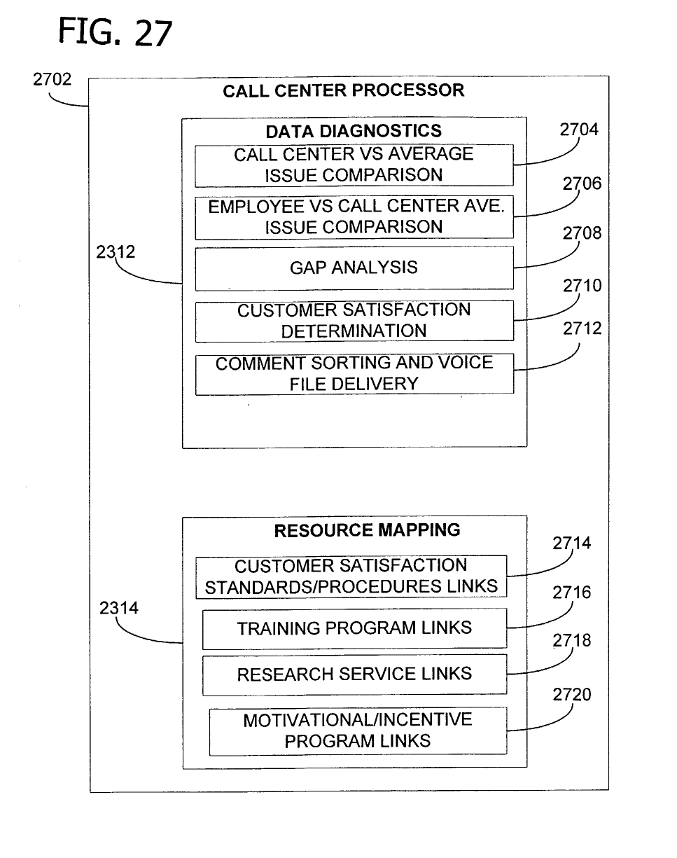

Referring next to FIG. 27, an exemplary block diagram illustrates the operations of a call center processor that analyzes customer satisfaction issues in call center transactions. The call center processor 2702 performs data diagnostics 2312 and resource mapping 2314.

In such an embodiment, the data diagnostics 2412 include the following: call center vs. average issue comparison 2704; employee vs. call center average issue comparison 2706; gap analysis 2708; customer satisfaction determination 2710; and comment sorting and voice file delivery 2712.

The call center vs. average issue comparison 2704 compares the performance of a particular call center to an overall average performance for one or more customer satisfaction issues. In this example, the overall average can be determined by normalizing or averaging CSI data from multiple call centers. For example, call center processor 2702 employs an averaging algorithm to determine the overall average from district, local, regional or national call center CSI data. The employee vs. call center average issue comparison 2706 compares the performance of a particular employee to the average performance of the call center's other employees for one or more customer satisfaction issues.

The gap analysis 2708 examines the variance between a particular call center's performance or a particular employee's performance and the corresponding average performance for one or more satisfaction issues. The call center processor 2702 performs the gap analysis by linking employee self assessment data, operational metrics data and customer satisfaction data on an item-by-item basis. The system then conducts analyses to determine items where these three information sources are out of alignment. One example might be an item where an employee rated oneself high (i.e. being courteous) but customers rated that individual low.

Customer satisfaction determination 2710 is performed by the call center processor 2702 in the same manner the automotive processor 2502 performs the customer satisfaction determination 2508. (See description of FIG. 25.).

Comment sorting and voice file delivery 2712 allows the user to experience or understand the transaction from the customers perspective by allowing users to choose digital voice recording (DVR) files associated with particular issues or call center personnel, and hear the customers comments.

In this embodiment, the resource mapping 2314 includes the following: customer satisfaction standards/procedures links 2714, a training program links 2716, research service links 2718, and motivational and incentive program links 2720. The customer satisfaction standards/procedures links 2714 link the user to online business procedures that provide guidelines for satisfying the customer. The training program links 2716 provide the user access to online information or services that assists employees to improve their customer service performance. The research service links 2718 enable the user to conduct directed on-line or other research directed to specific issues. The motivational and incentive program links 2720 direct the user to reward or recognition systems that encourage employees to improve their performance as it relates to specific customer satisfaction issues. Thus, the resource mapping performed by call center processor 2702 is similar to the resource mapping performed by the automotive processor 2502.

When introducing elements of the present invention or the preferred embodiment(s) thereof, the articles a, an, the, and said are intended to mean that there are one or more of the elements. The terms comprising, including, and having are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. A system for assisting a user in evaluating and responding to customer satisfaction index (CSI) data, said system comprising:
a database 102 including the CSI data in a hierarchical format;
a processor 104 for accessing the database and for providing a summary 106 of strengths and weaknesses indicated by the hierarchical CSI data;
a plurality of on-line service programs 108 for impacting the hierarchical CSI data; and
a resource mapping tool 110 for linking the strengths and weaknesses with the on-line service programs.

2. The system of claim 1 wherein the HCSI data includes attributes and wherein the resource mapping tool 110 includes a lookup table linking attributes with one or more of the on-line service programs 108.

3. A system for assisting a user in evaluating and responding to hierarchical customer satisfaction index (HCSI) data 102, said system comprising:
a data reporting tool 104 responsive to user input for generating summary survey data 106 of the HCSI data;
a diagnostic tool 112 responsive to user queries analyzing the summary survey data of the HCSI data to generate comparisons 114 and identify issues 116 relating to the HCSI data;
a plurality of on-line service programs 108 for impacting the HCSI data; and
a resource mapping tool 110 for linking the comparisons 114 and issues 116 with the on-line service programs 108.

4. The system of claim 3 wherein the diagnostic tool compares the summary survey data to a range and identifies strengths and weaknesses of the data as a function of the range.

5. The system of claim 3 wherein the summary survey data corresponds to user-defined criteria and/or corresponds to customer-defined criteria.

6. A modular system for assisting a user in analyzing hierarchical customer satisfaction (HCSI) data 202 generated by a business directed toward customers 204 according to business procedures 206 and motivation programs 208, said modular system comprising:
a reporting module 210 for providing on-line reporting of the HCSI data;
a diagnostic module 212 for viewing the reported HCSI data (via 214), and for generating comparisons and for identifying issues relating to the HCSI data;
a research module 216 for conducting on-line research corresponding to marketing activities and customer satisfaction (via 218) relating to the generated comparisons and identified issues;
a procedures module 220 for viewing pertinent business procedures (via learning system 222) relating to the generated comparisons and identified issues;
a training module 224 for providing and tracking via 226 on-line and/or off-line training affecting the generated comparisons, the identified issues and/or the pertinent procedures;
a sales and recognition building module 228 for tracking the motivation programs 208 and developing and implementing incentive programs 230 encouraging development of the business; and
a customer retention module 232 for engaging in relationship management between the business and the customer 204 and providing marketing activities 234 to the customer 204.

7. A modular system for assisting a user in analyzing hierarchical customer satisfaction (HCSI) data 202 generated by a business directed toward customers 204 according to business procedures 206 and motivation programs 208, said modular system comprising:
a reporting module 210 for providing on-line reporting of the HCSI data;
a diagnostic module 212 for viewing the reported HCSI data (via 214), and for identifying strengths and weaknesses of to the HCSI data; and
a training module 224 for providing and/or tracking on-line and/or off-line training affecting the identified strengths and weaknesses.

8. The system of claim 7 wherein the diagnostic module 212 comprises:
a data retrieval tool responsive to user input for dynamically generating a query to access the data to obtain selected CSI data; and
a report generating tool for dynamically generating a plurality of interlinked reports including the selected CSI data, each of said reports having at least one dynamically linked item wherein the report generating tool generates another report in response to a user selecting the dynamically linked item.

9. A computerized system for use by a user to dynamically analyze hierarchical customer satisfaction index (CSI) data in a database, said system comprising:
a data retrieval tool responsive to user input for dynamically generating a query to access the database to obtain selected CSI data; and
a report generating tool for dynamically generating a plurality of interlinked reports including the selected CSI data, each of said reports having at least one dynamically linked item wherein the report generating tool generates another report in response to a user selecting the dynamically linked item.

10. The computerized system of claim 9, wherein the item includes a dynamically-generated query, wherein the query dynamically produces another report by retrieving selected elements of the CSI data from the database.

11. The computerized system of claim 10, wherein the query includes code or text.

12. The computerized system of claim 9, wherein the reports include at least one query customized by the user to retrieve selected elements of the CSI data from the database.

13. The computerized system of claim 9, wherein the item is a hyperlink.

14. The computerized system of claim 9, wherein the database is accessible via a network.

15. The computerized system of claim 9, wherein the database is accessible via an application program.

16. The computerized system of claim 9, wherein the database includes local, regional, and national CSI data.

17. The computerized system of claim 9, wherein the reports include selected elements of the CSI data for display on a web page.

18. The computerized system of claim 9, wherein the reports include graphics and/or text.

19. The computerized system of claim 9, wherein the database includes dealer, customer, staff, or issue CSI data.

20. The computerized system of claim 19, wherein the reports include summaries of strengths and weaknesses of the CSI data relating to a dealer, customer, staff, or issue.

21. The computerized system of claim 19, wherein the database includes averages of the CSI data from all dealers.

22. The computerized system of claim 9, wherein the reports include charts customizable by the user to include selected CSI data.

23. A method for identifying problems and prioritizing areas for improvement related to customer satisfaction, said method comprising the steps of:
providing an application program with access to a database of hierarchical customer satisfaction index (CSI) data;
allowing a user to select and view one or more interlinked reports via the application program, said reports including dynamically linked items and selected CSI data; and
allowing the user to select one of the dynamically linked items in the reports to dynamically display another report.

24. The method of claim 23, further comprising the step of allowing the user to diagnose and compare the CSI data by creating at least one query to produce reports.

25. The method of claim 23, wherein the items relate to the CSI data of a dealer, customer, staff, or issue.

26. The method of claim 23, wherein the reports include the CSI data for a selected time period.

27. The method of claim 23, further comprising the steps of analyzing, sorting, and color-coding the CSJ data to highlight strong and weak performance.

28. The method of claim 23, further comprising the steps of identifying and presenting the CSI data based on pre-defined settings of the user.

29. A computerized system for use by a user to dynamically analyze hierarchical customer satisfaction index (CSI) data in a database, said system comprising a processor performing the steps of:
dynamically generating in response to user input a query accessing the database to obtain selected CSI data; and
dynamically generating a plurality of interlinked reports including the selected CSI data, each of said reports having at least one dynamically linked item wherein another report is generated in response to a user selecting the dynamically linked item.

30. A system for improving customer satisfaction comprising:
a report system for collecting and storing hierarchical customer satisfaction index (CSI) data, wherein said report system generates interlinked reports displaying selected CSI data; and
a diagnostic system for analyzing the CSI data, wherein said diagnostic system allows dynamic query generation and execution on the CSI data to dynamically display the interlinked reports.

31. A computerized system for assisting a user in analyzing customer satisfaction issues in transactions conducted between a customer and a representative, said system comprising:
a database for storing customer satisfaction index (CSI) data;
a processor responsive to user input for processing said CSI data, and for summarizing strengths and weaknesses of representatives indicated by said CSI data; and
a reporting tool providing to the user improvement programs relating to the summarized strengths and weaknesses of representatives.

32. The system of claim 31, wherein said representative is an employee or an agent of a business directed toward customers.

33. The system of claim 31, wherein the database comprises automotive CSI data and performance data including employee customer satisfaction data.

34. The system of claim 33, wherein the database comprises resource data including one or more of the following:
employee data; standards, procedures, and best practice data for specific issues as identified by the processor; training program data; research service data; and/or motivation and incentive program data.

35. The system of claim 33, wherein the processor is configured for performing data diagnostics including:
measuring performance of one or more satisfaction issues for a particular automotive dealer; and
comparing the measured performance of the particular automotive dealer to an overall average measured performance for the one or more satisfaction issues, wherein said overall average measured performance is determined from district, local, regional or national automotive CSI data;

36. The system of claim 33, wherein the processor is configured for performing data diagnostics including:
measuring performance of one or more satisfaction issues for a particular employee of a particular automotive dealer; and
comparing the measured performance of the particular employee to an average measured performance for the particular automotive dealer, wherein the average measured performance is determined from performance data of the particular automotive dealer.

37. The system of claim 33, wherein the processor is configured for performing data diagnostics including:
sorting automotive CSI data against a user defined threshold value to determine dissatisfied customers;
identifying loyalty drivers, said loyalty drivers determined from satisfaction issues shared among the identified loyal customers;
identifying loyalty drivers, said loyalty drivers determined from satisfaction issues shared among the identified loyal customers; and/or assessing CSI data to identify loyal customers and/or at-risk customers.

38. The system of claim 31, wherein the processor is configured for performing resource mapping including one or more of the following:
linking the user to customer satisfaction standards and/or customer satisfaction procedures;
linking the user to training programs;
linking the user to research services; and
linking the user to motivational and incentive programs.

39. The system of claim 31, wherein said processor prohibits database updates by the user.

40. The system of claim 31, wherein said reporting tool displays online and/or offline improvement programs.

41. The system of claim 31, wherein said reporting tool further displays training results.

42. The system of claim 31, wherein said improvement programs address customer satisfaction issues specific to individuals as identified by said processor.

43. The system of claim 31, wherein the database comprises call center CSI data and performance data including one or more of the following:
employee customer satisfaction data employee operational metrics; employee self assessment data; and/or employee supervisor assessment data.

44. The system of claim 43, wherein the database comprises resource data including one or more of the following: employee data; best practice data; training program data; and/or research service data.

45. The system of claim 43, wherein the processor is configured for performing data diagnostics including:
measuring performance of one or more satisfaction issues for a particular call center; and
comparing the measured performance of the particular call center to an overall average measured performance for the (same?) one or more satisfaction issues, wherein said overall average measured performance is determined from district, local, regional or national call center CSI data;

46. The system of claim 43, wherein the processor is configured for performing data diagnostics including:
measuring performance of one or more satisfaction issues for a particular employee of a particular call center; and
comparing the measured performance of the particular employee to an average measured performance for the particular call center, wherein the average measured performance is determined from performance data of the particular call center.

47. The system of claim 43, wherein the processor is configured for performing data diagnostics including:
analyzing performance gaps by linking employee self assessment, quality assessment results and customer satisfaction results;
sorting customer comments and delivering voice files; and/or
sorting call center CSI data against a user defined threshold value to determine dissatisfied customers.
